(19) United States
(12) Patent Application Publication
(10) Pub. No.: US 2025/0074096 A1
(43) Pub. Date: Mar. 6, 2025

(54) INK JET RECORDING METHOD AND INK JET RECORDING DEVICE

(71) Applicant: CANON KABUSHIKI KAISHA, Tokyo (JP)

(72) Inventors: YUKO NEGISHI, Tokyo (JP); EIICHI NAKATA, Kanagawa (JP)

(21) Appl. No.: 18/816,490

(22) Filed: Aug. 27, 2024

(30) Foreign Application Priority Data
Aug. 30, 2023 (JP) 2023-139412
Aug. 5, 2024 (JP) 2024-128716

(51) Int. Cl. B41M 3/00; B41J 2/21; C09D 11/037; C09D 11/322; C09D 11/40; C09D 11/54

(52) U.S. Cl. CPC B41M 3/008; B41J 2/21; B41M 3/001; C09D 11/037; C09D 11/322; C09D 11/40; C09D 11/54

(57) ABSTRACT

An ink jet recording method includes a first reaction liquid applying step, a first ink applying step, a second reaction liquid applying step and a second ink applying step in this order. A viscosity of a mixed liquid 1-1 obtained by mixing the first reaction liquid and the first ink at a mass ratio of 7:100 is higher than a viscosity of a mixed liquid 2-1 obtained by mixing the second reaction liquid and the first ink at a mass ratio of 7:100, and a viscosity of a mixed liquid 1-2 obtained by mixing the first reaction liquid and the second ink at a mass ratio of 7:100 is higher than a viscosity of a mixed liquid 2-2 obtained by mixing the second reaction liquid and the second ink at a mass ratio of 7:100.

### BACKGROUND

### Field

The present disclosure relates to an ink jet recording method and an ink jet recording device.

### Description of the Related Art

In recent years, an ink jet recording method has been widely used in the field of so-called sign and display, such as printing postures and large-format advertisements. The features of this field include a recording area wider than that of an ink jet recording device for household use. Further, since it is necessary for an image to be eye-catching, an ink that can record an image exhibiting high color developability is required to be used.

In the sign and display field, a non-absorbing recording medium which has a surface having almost no ink absorbability and is formed of polyvinyl chloride (PVC), polyethylene terephthalate (PET) or the like has been frequently used. Accordingly, bleeding of an image on a non-absorbing recording medium is required to be suppressed. Hereinafter, a recording medium having a surface that does not almost have ink absorbability will also be referred to as “non-absorbing recording medium”. In an ink jet recording method of recording an image on a non-absorbing recording medium, it is important to suppress bleeding by preventing ink dots from being repelled on the recording medium. Therefore, the ink is required to be rapidly thickened after application of the ink to the recording medium so that the ink is fixed to the recording medium.

As a method of recording an image on a non-absorbing recording medium, a recording method of using a solvent-based ink containing an organic solvent as a main component and a curable ink containing a polymerizable monomer is known. However, in recent years, from the viewpoints of the environmental load and odor, there is a growing need for a recording method of recording an image on a non-absorbing recording medium using an aqueous ink.

Examples of the method of recording an image on a non-absorbing recording medium using an aqueous ink include a method of evaporating moisture of an ink on a surface of a non-absorbing recording medium and a method of using a reaction liquid that aggregates components of an ink. The former method is advantageous from the viewpoint of the running cost because a unit that applies a reaction liquid is not required to be provided, but the productivity is degraded due to the need for reducing the recording speed. Therefore, a method of using a reaction liquid has been examined (see Japanese Patent Laid-Open No. 2015-147405).

### SUMMARY

The present inventors have performed recording on a non-absorbing recording medium using a first reaction liquid, a second reaction liquid, a first ink and a second ink described in Japanese Patent Laid-Open No. 2015-147405 and evaluated various characteristics. As a result, it has been found that a certain degree of an image quality can be obtained, but in a case where inks are applied in an overlapping manner, the ink applied later is embedded in the ink layer applied earlier to the recording medium. Further, it has also been found that the adhesiveness of an image (between the recording medium and the ink and between the inks) is insufficient. A phenomenon in which the ink applied later is embedded in the ink layer applied earlier to the recording medium in a case where the inks are applied in an overlapping manner is a phenomenon that can usually occur. However, it has been found that, as a result of the advance of the phenomenon in which the ink is embedded in the ink layer, the image appears differently, and thus an intended image cannot be obtained in some cases. In the present specification, “image in which embedding of the ink in the image is suppressed” denotes an image in which occurrence of degradation in image quality such as color developability caused by mixing of the ink applied earlier with the ink applied later is suppressed.

The present disclosure provides an ink jet recording method that enables suppression of embedding of an ink in an image when a plurality of inks are applied to a non-absorbing recording medium in an overlapping manner and enables recording of an image with excellent adhesiveness. Further, the present disclosure further provides an ink jet recording device and an aqueous ink that are used for the ink jet recording method.

According to the present disclosure, there is provided an ink jet recording method of ejecting a first ink, a second ink, a first reaction liquid and a second reaction liquid from a recording head to record an image on a recording medium such that the first ink, the second ink, the first reaction liquid and the second reaction liquid overlap each other on at least a part of a region of the recording medium, the method including in the following order: applying the first reaction liquid to the recording medium; applying the first ink to a region where the first reaction liquid has been applied; applying the second reaction liquid to the recording medium; and applying the second ink to a region where the second reaction liquid has been applied, in which the first ink is an aqueous ink containing a pigment, the second ink is an aqueous ink containing at least one particulate substance selected from the group consisting of a pigment and a resin particle, the first reaction liquid and the second reaction liquid are respectively an aqueous reaction liquid containing a reactant that reacts with an ink, the first reaction liquid contains a water-soluble cationic resin, a viscosity of a mixed liquid 1-1 obtained by mixing the first reaction liquid and the first ink at a mass ratio of 7:100 is higher than a viscosity of a mixed liquid 2-1 obtained by mixing the second reaction liquid and the first ink at a mass ratio of 7:100, a viscosity of a mixed liquid 1-2 obtained by mixing the first reaction liquid and the second ink at a mass ratio of 7:100 is higher than a viscosity of a mixed liquid 2-2 obtained by mixing the second reaction liquid and the second ink at a mass ratio of 7:100, and a water absorption amount of the recording medium from a start of contact to 30 msec^{1/2} in a Bristow method is 10 mL/m² or less.

Further features of the present disclosure will become apparent from the following description of exemplary embodiments with reference to the attached drawings.

### BRIEF DESCRIPTION OF THE DRAWINGS

FIG. 1 is a perspective view schematically showing an embodiment of an ink jet recording device according to the present disclosure.

FIG. 2 is a side view schematically showing an embodiment of an ink jet recording device according to the present disclosure.

FIG. 3 is a schematic view showing an embodiment of an ink jet recording device according to the present disclosure.

FIG. 4 is a perspective view showing an example of a liquid applying device.

FIG. 5 is a cross-sectional perspective view showing an example of an ejection element substrate.

FIG. 6 is a schematic view showing an example of a liquid supply system.

FIG. 7 is a schematic view showing another example of a heating unit.

FIG. 8 is a schematic view showing another example of a fixing unit.

### DESCRIPTION OF THE EMBODIMENTS

Hereinafter, the present disclosure will be described in more detail with reference to preferred embodiments. In the present disclosure, in a case where a compound is a salt, the salt is present by being dissociated in an ion state in an ink, but the expression “containing a salt” is used for convenience. Further, an ink jet aqueous ink and a reaction liquid will also simply referred to as “ink” and “reaction liquid”. A physical value is a value at room temperature (25° C.) unless otherwise specified. The term “(meth)acrylic acid” denotes “acrylic acid” or “methacrylic acid”, and the term “(meth)acrylate” denotes “acrylate” or “methacrylate”.

The present inventors have first examined the reason why embedding of the ink and degradation of the fixing properties of the image have occurred in the ink jet recording method of using two kinds of reaction liquids and two kinds of inks, described in Japanese Patent Laid-Open No. 2015-147405. In order to suppress embedding of the ink, it is necessary for the ink (first ink) applied earlier to be quickly aggregated to form a first ink layer. Therefore, the reaction liquid (first reaction liquid) applied along with the first ink is required to quickly cause aggregation (to have high reactivity) of the ink. Further, in a case where a reaction liquid that is as highly reactive as the first reaction liquid is used as the second reaction liquid applied along with the second ink, the second ink is difficult to follow the first ink layer. As a result, it is considered that the adhesiveness between the first ink layer and the second ink layer cannot be obtained, and thus the image is peeled off. Accordingly, embedding of the ink in the image and the adhesiveness of the image are considered to be improved by increasing the reactivity of the first reaction liquid and adjusting the reactivity of the second reaction liquid to be lower than the reactivity of the first reaction liquid. However, it has been found that the adhesiveness of the image still cannot be obtained even with the above-described configuration.

As a result of the examination, the present inventors have considered the reason why the adhesiveness of the image cannot be obtained as follows. In a case where the reactivity of the first reaction liquid used along with the first ink is increased, unevenness is likely to occur on the surface of the first ink layer. The unevenness is considered to occur not only on the surface in contact with the second ink but also on the surface in contact with the recording medium, and thus the followability to the recording medium is degraded. As a result, the adhesiveness of the image is insufficient. In consideration of the above-described circumstances, as a result of further examination conducted by the present inventors, it has been found that embedding of the ink in the image and the adhesiveness of the image can be improved by allowing the first reaction liquid to contain a water-soluble cationic resin.

That is, the ink jet recording method of the present inventors has the following features. First, the first ink is an aqueous ink containing a pigment. The second ink is an aqueous ink containing at least one particulate substance selected from the group consisting of a pigment and a resin particle. The first reaction liquid and the second reaction liquid are respectively an aqueous reaction liquid containing a reactant that reacts with an ink, and the reactant of the first reaction liquid contains a water-soluble cationic resin. The viscosity of a mixed liquid 1-1 obtained by mixing the first reaction liquid and the first ink at a mass ratio of 7:100 is higher than the viscosity of a mixed liquid 2-1 obtained by mixing the second reaction liquid and the first ink at a mass ratio of 7:100. Further, the viscosity of a mixed liquid 1-2 obtained by mixing the first reaction liquid and the second ink at a mass ratio of 7:100 is higher than the viscosity of a mixed liquid 2-2 obtained by mixing the second reaction liquid and the second ink at a mass ratio of 7:100. The water absorption amount of the recording medium from the start of contact to 30 msec^{1/2} in a Bristow method is 10 mL/m² or less. Further, the ink jet recording method includes a first reaction liquid applying step, a first ink applying step, a second reaction liquid applying step and a second ink applying step in this order. The present inventors have assumed that the mechanism by which embedding of an ink in an image can be suppressed and the adhesiveness of the image can be improved with the above-described configuration is as follows.

The first reaction liquid and the second reaction liquid are respectively an aqueous reaction liquid containing a reactant that reacts with an ink, and the first reaction liquid contains a water-soluble cationic resin. In addition, (i) the viscosity of the mixed liquid 1-1 obtained by mixing the first reaction liquid and the first ink at a mass ratio of 7:100 is higher than the viscosity of the mixed liquid 2-1 obtained by mixing the second reaction liquid and the first ink at a mass ratio of 7:100. Further, (ii) the viscosity of the mixed liquid 1-2 obtained by mixing the first reaction liquid and the second ink at a mass ratio of 7:100 is higher than the viscosity of the mixed liquid 2-2 obtained by mixing the second reaction liquid and the second ink at a mass ratio of 7:100. Here, the viscosities of the mixed liquids obtained by mixing the reaction liquids and the inks at the above-described mass ratios are the conditions assuming the reactivity when the reaction liquids and the inks are applied onto the recording medium to record an image. A case where the viscosity of the mixed liquid satisfies the relationship (i) denotes that the reactivity of the first reaction liquid to the first ink is higher than that of the second reaction liquid to the first ink. Further, a case where the viscosity of the mixed liquid satisfies the relationship (ii) denotes that the reactivity of the first reaction liquid to the second ink is higher than that of the second reaction liquid to the second ink. As described above, embedding of the ink in the image can be suppressed by allowing the viscosities of the mixed liquids to satisfy the conditions (i) and (ii). When the relationship (i) is not satisfied, this denotes that the reactivity of the first reaction liquid is lower than that of the second reaction liquid or the reactivity of the first reaction liquid is equal to the reactivity of the second reaction liquid. In a case where the reactivity of the first reaction liquid is lower than that of the second reaction liquid or the reactivity of the first reaction liquid is equal to the reactivity of the second reaction liquid, embedding of the ink in the image cannot be suppressed as described above. Further, when the relationship (ii) is not satisfied, this denotes that the second reaction liquid quickly aggregates the second ink, and thus the adhesiveness between the first ink layer and the second ink layer cannot be obtained. As a result, the adhesiveness of the image cannot be obtained.

The unevenness of the ink layer that occurs as a result of increasing the reactivity is filled with a precipitated cationic resin by using the first reaction liquid containing a water-soluble cationic resin. In addition, the viscosity at the surface in contact with the recording medium is improved, and thus the adhesiveness of the image can be improved. In a case where the first reaction liquid contains an organic acid or a polyvalent metal salt as a reactant in place of the cationic resin, the effects of the cationic resin are not exhibited, and accordingly, the adhesiveness of the image cannot be obtained. Further, in a case where recording is performed on an absorbing recording medium, since liquid components of each reaction liquid and each ink are quickly absorbed by the recording medium, the problems of embedding of the second ink in the first ink layer and degradation of the adhesiveness of the image do not occur.

### Ink Jet Recording Method and Ink Jet Recording Device

The ink jet recording method of the present disclosure is a method of recording an image by ejecting aqueous inks and aqueous reaction liquids using the action of thermal energy from an ink jet type recording head and applying the aqueous inks and the reaction liquids to a recording medium. The ink jet recording method of the present disclosure includes the first reaction liquid applying step, the first ink applying step, the second reaction liquid applying step and the second ink applying step in this order. The first reaction liquid applying step is a step of applying the first reaction liquid to the recording medium, and the first ink applying step is a step of applying the first ink to a region where the first reaction liquid is applied. The second reaction liquid applying step is a step of applying the second reaction liquid to the recording medium, and the second ink applying step is a step of applying the second ink to a region where the second reaction liquid is applied. The first reaction liquid and the second reaction liquid are respectively an aqueous reaction liquid that contains a reactant reacting with an ink, and the first reaction liquid contains a water-soluble cationic resin. The first ink contains a pigment. The second ink contains at least one particulate component selected from the group consisting of a pigment and a resin particle.

The recording medium is a recording medium in which the water absorption amount from the start of contact to 30 msec^{1/2} in a Bristow method is 10 mL/m² or less.

The ink jet recording device of the present disclosure is a device used for an ink jet recording method of recording an image by ejecting aqueous inks and aqueous reaction liquids using the action of thermal energy from an ink jet type recording head and applying the aqueous inks and the aqueous reaction liquids to the recording medium. The ink jet recording device of the present disclosure is a device suitably used for the recording method described above. In the present disclosure, it is not necessary to provide a step of irradiating the image with active energy rays or the like to cure the image.

The aqueous inks of the present disclosure are a set used for the ink jet recording method of ejecting the aqueous inks and the aqueous reaction liquids containing a reactant that reacts with the aqueous inks from the recording head to record an image on the recording medium. Further, the set is suitably used for the above-described recording method. Examples of the form of the set include a set of a plurality of ink cartridges each independently accommodating a plurality of inks (reaction liquids) and an ink cartridge in a state of being integrally formed by combining a plurality of ink accommodating units each accommodating a plurality of inks (reaction liquids). The set of the present disclosure is not limited to the above-described forms as long as the set is formed to use a combination of inks and reaction liquids, and may be in any form.

Hereinafter, the ink jet recording method and the ink jet recording device (hereinafter, also simply referred to as “recording method” and “recording device”) of the present disclosure will be described in detail.

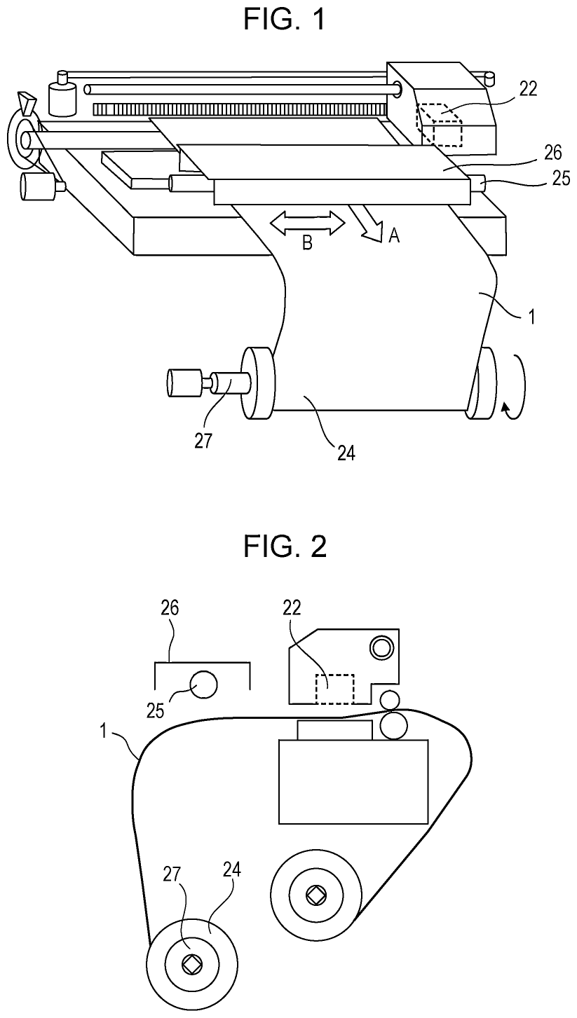

FIG. 1 is a perspective view schematically showing an embodiment of the ink jet recording device according to the present disclosure.

Further, FIG. 2 is a side view schematically showing an embodiment of the ink jet recording device according to the present disclosure. As shown in FIGS. 1 and 2, the recording device of the present disclosure includes an ink jet type recording head 22 that ejects an ink. The recording head 22 is a recording head that ejects an ink by the action of the thermal energy. The recording head that ejects an ink by the action of the thermal energy applies the thermal energy to the ink by applying an electric pulse to an electrothermal conversion element, to eject the ink from an ejection orifice. Here, the description has been made using the recording head that ejects an ink by the action of the thermal energy as an example, but a recording head that ejects an ink by an action of mechanical energy may be employed. The recording head may include a mechanism (temperature adjustment mechanism) that heats an aqueous ink ejected from the recording head. In a case where the recording head includes a temperature adjustment mechanism, it is preferable that the heating temperature of the ink ejected from the recording head be set to 35° C. or higher to 70° C. or lower. Further, it is preferable that the first ink and the second ink, and the first reaction liquid and the second reaction liquid be respectively applied to a unit area of the recording medium by a plurality of times of relative scanning of the recording head and the recording medium.

### Heating Step

A recording method of the present disclosure may include a step of heating the recording medium to which the ink has been applied (heat treatment). When the recording medium to which the ink has been applied is heated, drying of the recording medium can be promoted, or the strength of the image can be increased.

Examples of a method of heating the recording medium include a known temperature increasing method of using a heater or the like, an air blowing method of blowing air using a dryer or the like, and a heating method of combining these methods. Examples of the heating method include the temperature increasing method, the air blowing method, and the method of combining these methods described above. Examples of a method performing the heat treatment include a method of applying heat from a side of the recording medium (rear surface) opposite to the recording surface (surface onto which the ink has been applied) using a heater or the like, a method of applying warm air or hot air to the recording surface of the recording medium, and a method of heating the recording surface or the rear surface using an infrared heater. Further, a plurality of these methods may be used in combination.

From the viewpoint of enhancing the abrasion resistance of an image, it is preferable that the heating temperature of the recording medium to which the ink and the reaction liquid have been applied be set to 50° C. or higher to 90° C. or lower. The heating temperature of the recording medium to which the ink has been applied may be read by a sensor installed in a position corresponding to a heating unit of the recording device or may be determined based on the relationship between the temperature of the recording medium and the amount of heat determined according to the kinds of the ink and the recording medium.

In the recording device shown in FIGS. 1 and 2, a heater 25 supported by a frame (not shown) is disposed in a position downstream of a sub-scanning direction A with respect to a position where the recording head 22 performs reciprocal scanning in a main scanning direction B. A recording medium 1 to which the ink has been applied can be heated by the heater 25. Specific examples of the heater 25 include a sheathed heater and a halogen heater. The heater 25 is covered by a heater cover 26. The heater cover 26 is a member for efficiently irradiating the recording medium 1 with heat generated from the heater 25. Further, the heater cover 26 is a member that also protects the heater 25. The recording medium 1 to which the ink ejected from the recording head 22 has been applied is wound up by a winding spool 27 to form a roll-like winding medium 24.

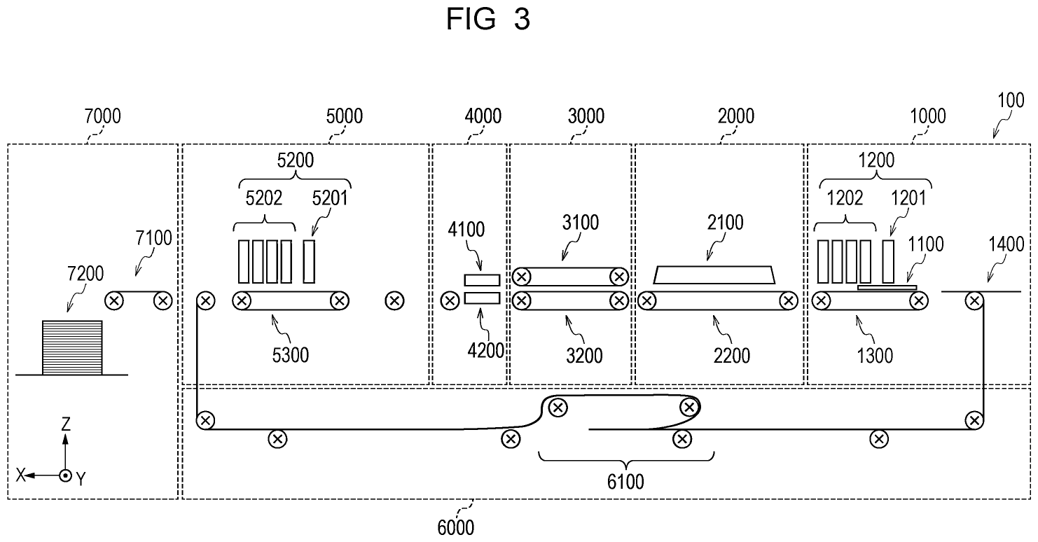

FIG. 3 is a schematic view showing an embodiment of the ink jet recording device according to the present disclosure. The ink jet recording device of the present embodiment is an ink jet recording device that records an image on a recording medium using an ink and a reaction liquid containing a reactant reacting with the ink. The X direction, the Y direction and the Z direction each denote the width direction (entire length direction), the depth direction and the height direction of the ink jet recording device. The recording medium is conveyed in the X direction.

An ink jet recording device 100 according to the embodiment shown in FIG. 3 is configured to include a first recording unit 1000, a heating unit 2000, a fixing unit 3000, a cooling unit 4000, a second recording unit 5000, an inverting unit 6000 and a paper discharge unit 7000. In the first recording unit 1000, various liquids are applied by a liquid applying device 1200 to a recording medium 1100 conveyed by a conveyance member 1300 from a feeding device 1400. In the heating unit 2000, the liquid applied to the recording medium 1100 is heated by a heating device 2100, and volatile components such as moisture in the liquid are evaporated to dry the recording medium 1100.

In the fixing unit 3000, the recording medium 1100 is heated by bringing a fixing member 3100 into contact with a region where the liquid has been applied to the recording medium 1100, to promote the fixation of an image to the recording medium 1100. Thereafter, the recording medium 1100 is cooled by a cooling member 4100 of the cooling unit 4000. In the second recording unit 5000, various liquids are applied by a liquid applying device 5200 to the recording medium 1100. In a case where an image is recorded on the rear surface of the recording medium after an image is recorded on the front surface (recording surface), first, the recording medium 1100 is inverted by an inverting device 6100 of the inverting unit 6000. Next, the recording medium 1100 is conveyed by a conveyance member 7100 of the paper discharge unit 7000 after an image is recorded on the rear surface of the recording medium 1100 in the same manner as the recording on the front surface, and the recording medium 1100 is stacked on and accommodated in a recording medium accommodating unit 7200.

### Recording Unit

The first recording unit 1000 includes a liquid applying device 1200. The liquid applying device 1200 is configured to include a reaction liquid applying device 1201 and an ink applying device 1202. The reaction liquid applying device 1201 shown in FIG. 1 is an example of a unit formed of an ink jet type ejection head.

In addition, the reaction liquid applying device may be configured by using a gravure coater, an offset coater, a die coater, a blade coater or the like. The application of the reaction liquid using the reaction liquid applying device 1201 may be performed before or after the application of the ink as long as the reaction liquid can be brought into contact with the ink on the recording medium 1100. Here, it is preferable that the reaction liquid be applied before the application of the ink in order to record a high-quality image on various recording media with different liquid absorption characteristics. An ink jet type ejection head (recording head) is used as the ink applying device 1202. Examples of an ejection method of the ejection head serving as the liquid applying device 1200 include a method of ejecting a liquid by causing film boiling in the liquid using an electrothermal converter to form air bubbles and a method of ejecting a liquid using an electromechanical converter. From the viewpoint of the image quality, it is preferable that the time taken until the reaction liquid comes into contact with the ink be short. Specifically, the time taken from the application of the reaction liquid to the application of the ink is preferably 1100 milliseconds or shorter. The time taken from the application of the reaction liquid to the application of the ink can be adjusted by adjusting the interval between applying units or adjusting the conveyance speed. The time between the application of the first reaction liquid and the application of the first ink and the time between the application of the second reaction liquid and the application of the second ink may be the same as or different from each other.

Further, as shown in FIG. 3, the application of the first ink and the second ink and the application of the first reaction liquid and the second reaction liquid to a unit area of the recording medium may be respectively performed by a plurality of times of relative scanning of the recording head and the recording medium. In this case, from the viewpoint of forming the first ink layer, it is preferable that a difference in time between the application of the first ink and the application of the second reaction liquid to the unit area of the recording medium be set to 5 seconds or longer.

When the difference in application time is shorter than 5 seconds, the first ink layer is not formed in time, and thus embedding of the ink in the image cannot be sufficiently suppressed in some cases.

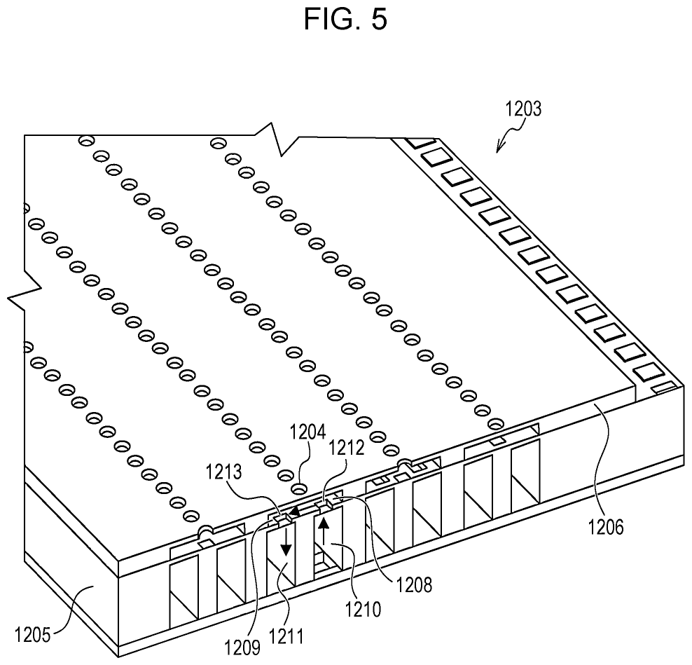

The liquid applying device 1200 is a line head extending in the Y direction, and ejection orifices are arranged in a range where an image recording area of the available recording medium with the maximum width is covered. The ejection head on the lower side (recording medium 1100 side) has an ejection orifice surface 1207 (FIG. 5) having an ejection orifice formed therein, and the ejection orifice surface faces the recording medium 1100 with an extremely small distance of several millimeters.

A plurality of ink applying devices 1202 may be provided to apply inks of each color to the recording medium 1100. For example, in a case where images of each color are recorded using a yellow ink, a magenta ink, a cyan ink and a black ink, four ink applying devices 1202 for ejecting four kinds of inks described above are arranged side by side in the X direction. Hereinafter, the inks and the reaction liquids will also be collectively referred to as “liquid”.

The second recording unit 5000 includes the liquid applying device 5200. The liquid applying device 5200 is configured to include a reaction liquid applying device 5201 and an ink applying device 5202. The same configurations as those for the first recording unit can be used as various configurations of the second recording unit. Further, the first recording unit and the second recording unit are not necessarily separately configured as shown in FIG. 1. For example, a plurality of reaction liquid applying devices 1201 and ink applying devices 1202 are arranged in the first recording unit, and the recording medium may be returned to the first recording unit downstream of the cooling unit 4000 to perform recording. In this case, the reaction liquid applying device 1201 and the ink applying device 1202 used when the recording medium passes through the first recording unit 1000 for the first time may be respectively the same as or different from the reaction liquid applying device 1201 and the ink applying device 1202 used when the recording medium passes through the first recording unit 1000 for the second time.

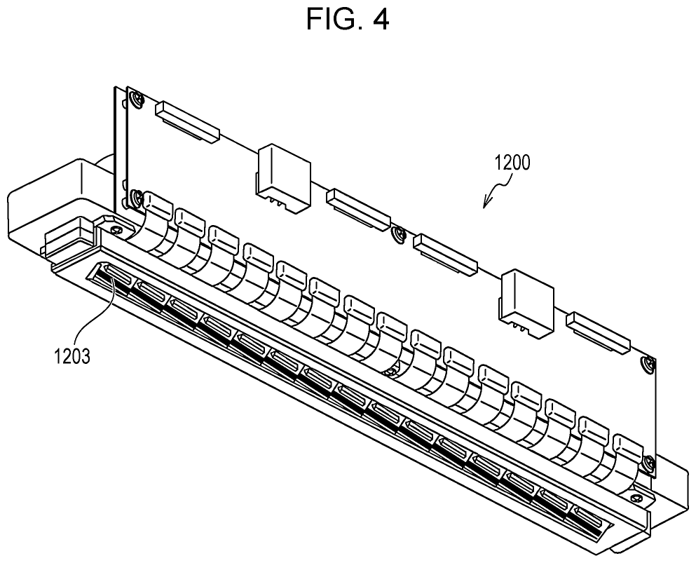

FIG. 4 is a perspective view showing an example of the liquid applying device. The liquid applying device 1200 shown in FIG. 4 is a line head, and a plurality of ejection element substrates 1203 each provided with an ejection orifice array are arranged in a straight line. A plurality of ejection orifice arrays are arranged in the ejection element substrate 1203.

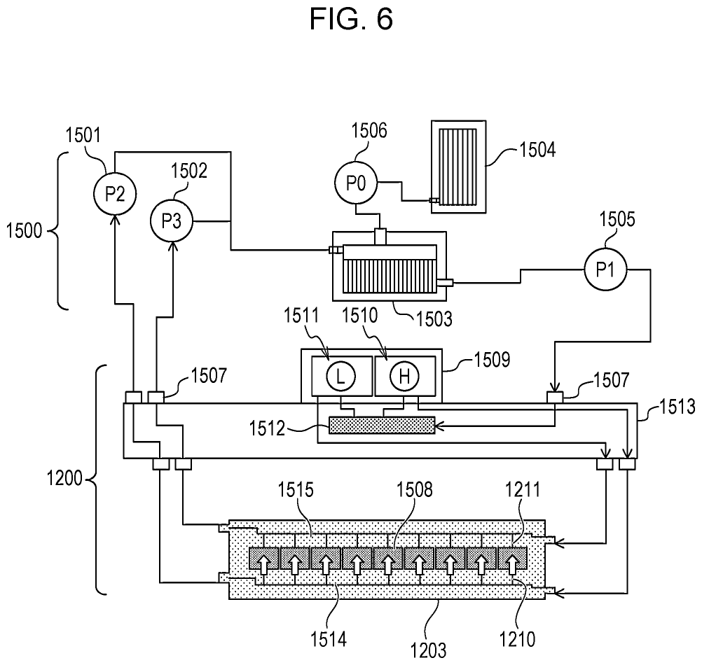

FIG. 5 is a cross-sectional perspective view showing an example of the ejection element substrate. The ejection element substrate 1203 shown in FIG. 5 includes an ejection orifice forming member 1206 having ejection orifices 1204 that are open and a substrate 1205 provided with an ejection element (not shown). A first channel 1208 and a second channel 1209 through which the liquid flows are formed by laminating the ejection orifice forming member 1206 and the substrate 1205. The first channel 1208 is a region from an inflow port 1212 into which the liquid flows from an inflow path 1210 to a portion (liquid chamber 1508 in FIG. 6) between the ejection orifice 1204 and the ejection element. Further, a second channel 1209 is a region from a portion (liquid chamber 1508 in FIG. 6) between the ejection orifice 1204 and the ejection element to an outflow port 1213 from which the liquid outflows to an outflow path 1211. For example, in a case where a difference in pressure is provided between the inflow port 1212 and the outflow port 1213 such that the inflow port 1212 is under a higher pressure and the outflow port 1213 is under a lower pressure, the liquid can be allowed to flow from a side where the pressure is higher to a side where the pressure is lower (in directions indicated by the arrows in FIG. 5). The liquid having passed through the inflow path 1210 and the outflow port 1212 flows into the first channel 1208. Further, the liquid having passed through the portion (liquid chamber 1508 in FIG. 6) between the ejection orifice 1204 and the ejection element passes through the second channel 1209 and the outflow port 1213 and flows into the outflow path 1211.

### Supply System

FIG. 6 is a schematic view showing an example of a supply system for the liquid such as the ink. A supply unit 1500 of the liquid applying device 1200 shown in FIG. 6 is configured to include a first circulation pump (high-pressure side) 1501, a first circulation pump (low-pressure side) 1502, a sub-tank 1503 and a second circulation pump 1505. The sub-tank 1503 connected to the main tank 1504 serving as a liquid accommodating unit includes an air communication port (not shown) and is capable of discharging air bubbles, which have been mixed into the liquid, to the outside of the circulation system. The sub-tank 1503 is also connected to a replenishing pump 1506. The liquid is consumed in the liquid applying device 1200 by ejecting (discharging) the liquid from the ejection orifice for recording an image, suction recovery or the like. The replenishing pump 1506 transfers the liquid in an amount corresponding to the amount consumed from the main tank 1504 to the sub-tank 1503.

The first circulation pump (high-pressure side) 1501 and the first circulation pump (low-pressure side) 1502 cause the liquid inside the liquid applying device 1200 that has flowed from a connecting portion (inlet portion) 1507, to flow into the sub-tank 1503. It is preferable that positive displacement pumps having a quantitative liquid feeding ability be used as the first circulation pump (high-pressure side) 1501, the first circulation pump (low-pressure side) 1502 and the second circulation pump 1505. Examples of such positive displacement pumps include a tube pump, a gear pump, a diaphragm pump and a syringe pump. The liquid can be allowed to flow from a common inflow path 1514 to a common outflow path 1515 by the first circulation pump (high-pressure side) 1501 and the first circulation pump (low-pressure side) 1502 when the ejection element substrate 1203 is driven.

A negative pressure control unit 1509 includes two pressure adjustment mechanisms with control pressures set to be different from each other. A pressure adjustment mechanism (high-pressure side) 1510 and a pressure adjustment mechanism (low-pressure side) 1511 are respectively connected to the common inflow path 1514 and the common outflow path 1515 in the ejection element substrate 1203 through a supply unit 1513 provided with a filter 1512 that removes foreign matter from the liquid. The ejection element substrate 1203 is provided with the common inflow path 1514, the common outflow path 1515, and an inflow path 1210 and an outflow path 1211 that communicate with a liquid chamber 1508 which is a portion between the ejection orifice 1204 and the ejection element (not shown). Since the inflow path 1210 and the outflow path 1211 respectively communicate with the common inflow path 1514 and the common outflow path 1515, a flow (indicated by the arrows in FIG. 6) in which a part of the liquid flows from the common inflow path 1514 to the common outflow path 1515 through the inside of the liquid chamber 1508 is generated. The arrows in FIG. 5 indicate the flow of the liquid inside the liquid chamber 1508. That is, the liquid inside the first channel 1208 flows into the second channel 1209 through a space between the ejection orifice 1204 and the ejection element as shown in FIG. 5.

As shown in FIG. 6, since the pressure adjustment mechanism (high-pressure side) 1510 is connected to the common inflow path 1514, and the pressure adjustment mechanism (low-pressure side) 1511 is connected to the common outflow path 1515, a difference in pressure occurs between the inflow path 1210 and the outflow path 1211. In this manner, a difference in pressure occurs even between the inflow port 1212 (FIG. 5) communicating with the inflow path 1210 and the outflow port 1213 (FIG. 5) communicating with the outflow path 1211. In a case where the liquid is allowed to flow using the difference in pressure between the inflow port 1212 and the outflow port 1213, it is preferable that the flow rate (mm/s) of the liquid be controlled to 0.1 mm/s or more to 10.0 mm/s or less.

### Conveyance System

As shown in FIG. 3, the first recording unit 1000 is configured to include the liquid applying device 1200 and the conveyance member 1300 that conveys the recording medium 1100. The reaction liquid and the ink are applied by the liquid applying device 1200 to a desired position of the recording medium 1100 to be conveyed by the conveyance member 1300. Each liquid applying device receives an image signal of recording data and applies the reaction liquid and the ink required for each position. FIG. 1 shows the conveyance member 1300 as a form of a conveyance belt, but a spur, a conveyance cylinder or the like may be used as the conveyance belt as long as these members have a function of conveying the recording medium 1100. A conveyance member capable of fixing the recording medium 1100 can be used as the conveyance member 1300 in order to increase the conveyance accuracy. Specific examples of a method of fixing the recording medium include a method of providing a hole in the conveyance member 1300 and suctioning the recording medium 1100 from the rear surface side thereof so that the recording medium 1100 is fixed and a method of forming the conveyance member 1300 using an appropriate material and electrostatically adsorbing the recording medium 1100 so that the recording medium 1100 is fixed. The second recording unit 5000 can have the same configurations as those for the first recording unit 1000.

### Heating Unit

As shown in FIG. 3, the heating unit 2000 is configured to include the heating device 2100 and a conveyance member 2200. The liquid component of an image is evaporated and dried by, using the heating device 2100, heating the recording medium 1100 where the reaction liquid and the ink have been applied and an image has been recorded while conveying the recording medium 1100 by the conveyance member 2200. It is preferable that a drying step of drying the ink by heating the recording medium to which the ink has been applied in a non-contact manner be further provided between the ink applying step and the fixing step. When such a drying step is provided, deformation (cockling or curling) of the recording medium 1100 can be effectively suppressed.

The heating device 2100 may have any configuration as long as the recording medium 1100 can be heated, and various known devices of the related art, such as a hot air dryer and heater, can be used. Among these, it is preferable to use a non-contact heater such as a heating wire or an infrared ray from the viewpoint of the safety or energy efficiency. Further, when a mechanism that sends hot air by a built-in fan for blowing heated gas to the recording medium 1100 is used, the drying efficiency is likely to be enhanced.

The method of heating the recording medium 1100 may be performed by heating the surface (recording surface (front surface)) side of the recording medium 1100 to which the reaction liquid and the ink have been applied, the rear surface side of the recording medium 1100 or both surfaces thereof. The conveyance member 2200 may have a function of heating the recording medium. FIG. 3 shows the conveyance member 2200 using the conveyance belt, but a spur, a conveyance cylinder or the like may be used as long as these members have a function of conveying the recording medium 1100. From the viewpoint of suppressing deformation of the recording medium 1100 due to heating, it is preferable to provide a configuration in which the recording medium 1100 is conveyed while being in close contact with the conveyance member 2200 or a mechanism in which the recording medium is fixed to the conveyance member 2200 by blowing air from the heating unit 2000. Specific examples of a method of fixing the recording medium include a method of providing a hole in the conveyance member 2200 and suctioning the recording medium 1100 from the rear surface side thereof so that the recording medium 1100 is fixed and a method of forming the conveyance member 2200 using an appropriate material and electrostatically adsorbing the recording medium 1100 so that the recording medium 1100 is fixed.

From the viewpoint of quickly evaporating the liquid component and suppressing deformation of the recording medium 1100, it is preferable that the heating temperature be set such that the recording medium is not over-heated. In consideration of the conveyance speed and the environment temperature, the temperature of a drying unit can be set such that the recording medium has a desired temperature. Specifically, the temperature of the drying unit (hot air or the like) is set to preferably 40° C. or higher to 100° C. or lower and more preferably 60° C. or higher to 80° C. or lower. Further, in a case where the recording medium 1100 is heated by blowing heated gas, it is preferable that the wind speed be set to 1 m/s or more to 100 m/s or less. The temperature of the wind such as hot air can be measured by using a K-type thermocouple thermometer. Specific examples of the measuring device include “AD-5605H” (trade name, manufactured by A&D Company, Limited).

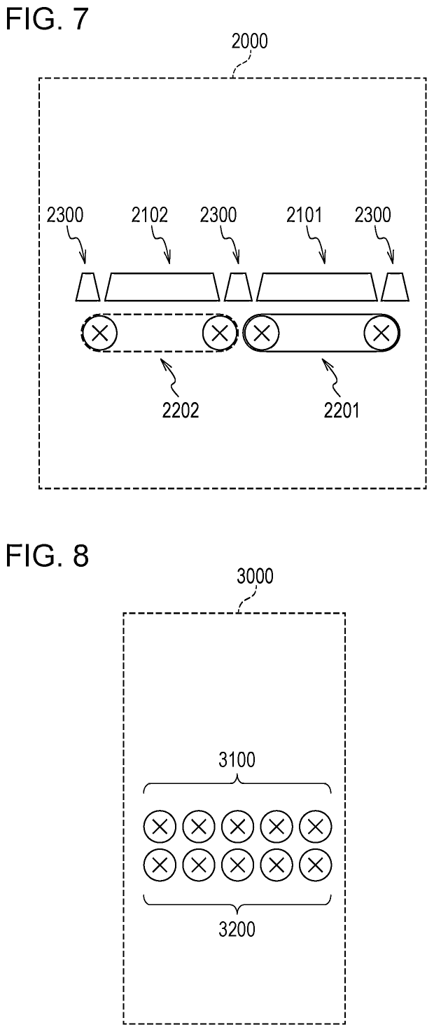

FIG. 7 is a schematic view showing another example of the heating unit. Here, a difference between the heating unit shown in FIG. 7 and the heating unit described above will be described. The heating unit 2000 shown in FIG. 7 includes a first heating device 2101 and a second heating device 2102, and a first conveyance member 2201 and a second conveyance member 2202 respectively disposed opposite to the first heating device 2101 and the second heating device 2102.

The first conveyance member 2201 is not provided with a mechanism for suctioning and fixing the recording medium 1100. Further, the recording medium 1100 is conveyed by pressing the recording medium 1100 against the first conveyance member 2201 using hot air blown by the first heating device 2101. In this manner, the recording medium 1100 can be accurately transferred from the conveyance member 1300 (FIG. 3) to the first conveyance member 2201 and from the first conveyance member 2201 to the second conveyance member 2202. Further, a conveyance deviation caused by a slight difference in conveyance speed between the conveyance member 1300 (FIG. 3) and the first conveyance member 2201 can be reduced. Further, the recording medium 1100 is conveyed while being fixed to the second conveyance member 2202 by a suction mechanism (not shown) using, as the second conveyance member 2202, a conveyance belt provided with a hole into which gas can be transmitted.

An air knife 2300 is disposed between the conveyance member 1300 (FIG. 3) and the first conveyance member 2201, between the first conveyance member 2201 and the second conveyance member 2202, and between the second conveyance member 2202 and the conveyance member 3200 (FIG. 3). The air knife 2300 suppresses, using the wind pressure thereof, a leading edge of the conveyed recording medium 1100 from floating up. In this manner, collision of the leading edge of the recording medium 1100 with the first heating device 2101, the second heating device 2102 and the fixing member 3100 (FIG. 3) can be avoided, and occurrence of conveyance failure can be suppressed.

The first heating device 2101 and the second heating device 2102 may have the same configuration as that for the heating device 2100 described above. The temperatures of the first heating device 2101 and the second heating device 2102 and the wind speeds thereof in a case of heating the recording medium by blowing heated gas to the recording medium may be same as or different from each other. Further, the recording medium may be heated by the first conveyance member 2201 and the second conveyance member 2202 as necessary.

### Fixing Unit

As shown in FIG. 3, the fixing unit 3000 is a contact type heating and pressurizing mechanism including the fixing member 3100 serving as a fixing belt, such as an endless belt, and the conveyance member 3200. In the fixing unit 3000, the recording medium 1100 is conveyed by the conveyance member 3200 and brought into contact with the fixing member 3100 in a state where the fixing member 3100 is pressurized against the recording medium 1100, and the liquids such as the reaction liquid, the ink and the like applied to the recording medium 1100 are heated. In this manner, the image can be fixed to the recording medium 1100. In the recording medium 1100 on which the image has been recorded, the liquid components of the reaction liquid and the ink are evaporated by permeating into the recording medium 1100 or passing through the heating unit 2000, the image is completed by being fixed to the recording medium 1100 by the fixing unit 3000. The recording medium 1100 is heated and pressurized in a state where the recording medium 1100 is sandwiched between the fixing member 3100 and the conveyance member 3200, and thus the image of the recording medium 1100 and the fixing member 3100 are brought into close contact, and the image is fixed to the recording medium 1100. When a liquid such as an ink containing a resin particle and a coloring material is used, the resin particle is softened by being heated mainly by the fixing unit 3000 for film formation, and the coloring material can be bound onto the recording medium 1100.

Examples of a method of heating the fixing member 3100 include a method of heating the fixing member by providing a heat source such as a halogen heater inside a roller that drives the fixing member 3100 as a fixing belt. Further, other examples thereof include a method of heating the fixing member by providing a heat source such as an infrared heater at a site different from the site of the fixing member 3100. In addition, these methods may be used in combination. The conveyance member 3200 may be heated as necessary. In consideration of the conveyance speed and the environment temperature, the temperature of the fixing member 3100 can be set such that the surface of the recording medium has a desired temperature. Specifically, the temperature of the fixing member 3100 is set to preferably 50° C. or higher to 120° C. or lower and more preferably 60° C. or higher and 110° C. or lower. Both the temperature of the contact type heating and pressurizing mechanism (fixing member 3100) and the surface temperature of the recording medium immediately after the recording medium passes through the contact type heating and pressurizing mechanism can be measured using a radiation thermometer. The radiation thermometer may be installed in the vicinity of an end portion (terminal end) of the contact type heating and pressurizing mechanism. Specific examples of the radiation thermometer include “Radiation Thermometer IT-545S” (trade name, manufactured by Horiba, Ltd.).

In a case where the ink contains a resin particle, the resin particle is likely to be softened and form a film, and thus the abrasion resistance of the image can be improved when the temperature of the fixing member 3100 is set to a temperature higher than or equal to the glass transition temperature of the resin particle in the ink. In a case where the ink contains a wax particle, it is preferable that the temperature of the fixing member 3100 be set to a temperature lower than the melting point of the wax constituting the wax particle. In this manner, the wax that is suppressed from being melted is likely to remain on the surface of the image, and thus the abrasion resistance of the image can be improved.

The nip pressure of the fixing member 3100 and conveyance member 3200, that is, the pressure applied to the recording medium when the recording medium passes through the contact type heating and pressurizing mechanism is preferably 10 Pa or more to 1000 Pa or less, more preferably 10 Pa or more to 500 Pa or less, and particularly preferably 10 Pa or more to 400 Pa or less. The time (nip time) required for the recording medium to pass through the contact type heating and pressurizing mechanism is preferably 0.25 seconds or longer to 5.0 second or shorter, more preferably 0.5 seconds or longer to 4.0 seconds or shorter, and particularly preferably 1.0 seconds or longer to 3.0 seconds or shorter.

FIG. 8 is a schematic view showing another example of the fixing unit. Here, a difference between the fixing unit shown in FIG. 3 and the fixing unit described above will be described. The fixing unit 3000 shown in FIG. 8 is a contact type heating and pressurizing mechanism configured to include a plurality of fixing rollers 3101 and a plurality of conveyance members 3201 disposed opposite to the fixing rollers 3101. An image is fixed to the recording medium by allowing the recording medium 1100 to which the liquid such as the ink has been applied to pass through between the fixing roller 3101 and the conveyance member 3201. The degree of image fixation onto the recording medium can be adjusted by controlling the number of the fixing rollers 3101 and the conveyance members 3201, and the nip time, the temperature and the pressure of the recording medium, which are affected by the fixing rollers and the conveyance members.

### Cooling Unit

The cooling unit 4000 is configured to include the cooling member 4100 and the conveyance member 4200 (FIG. 3). The cooling unit 4000 cools the recording medium 1100 that has been heated to a high temperature after passing through the heating unit 2000 and the fixing unit 3000. The cooling member 4100 may have any configuration as long as the recording medium 1100 can be cooled, and an air cooling method, a water cooling method or the like can be used for cooling the recording medium. Among these, it is preferable that the recording medium be cooled by blowing unheated gas thereto from the viewpoints of the safety and the energy efficiency. Further, the cooling efficiency is likely to be enhanced when a mechanism that a fan for blowing gas to the recording medium 1100 is built-in and sends gas is used. In consideration of the conveyance speed and the environment temperature, the temperature of a cooling unit can be adjusted such that the image of the recording medium reaches a desired temperature. Specifically, the temperature of the cooling unit (blowing air or the like) is set to preferably 20° C. or higher to 60° C. or lower and more preferably 25° C. or higher to 50° C. or lower. In a case where the recording medium is cooled by blowing gas, it is preferable that the wind speed be set to 1 m/s or more to 100 m/s or less. When the recording medium is under the above-described conditions, deformation of the recording medium 1100 to be stacked in a paper discharge unit 6000 described below and sticking (blocking) of the image to the recording medium can be suppressed.

The heating unit, the fixing unit and the cooling unit may be provided on a rear side of the second recording unit 5000. In this case, the heating unit, the fixing unit and the cooling unit may have configurations that are the same as or different from those described above.

### Inverting Unit

In a case where two-sided recording is performed, the recording medium 1100 is inverted by using the inverting unit 6000 (FIG. 3). The recording medium 1100 having the recording surface (front surface) on which the image has been recorded passes through the cooling unit 4000, branched, conveyed and inverted by the inverting device 6100. The inverted recording medium 1100 is conveyed to the feeding device 1400 of the recording unit 1000 in a state where the liquid is applied to the rear surface (surface on a side opposite to the recording surface (front surface)) thereof.

### Paper Discharge Unit

The recording medium 1100 after image recording is accommodated in the paper discharge unit 7000 (FIG. 3). After one-side or two-sided recording is performed, the recording medium 1100 having passed through the cooling unit 4000 is conveyed by the conveyance member 7100 and finally accommodated in the recording medium accommodating unit 7200 in a state of being stacked. In order to respectively accommodate different recorded materials, two or more recording medium accommodating units 7200 may be provided.

### Recording Medium

In the recording method and the recording device of the present disclosure, a non-absorbing recording medium (low to non-absorbing recording medium) is used. The low to non-absorbing recording medium is a recording medium in which the water absorption amount from the start of contact to 30 msec^{1/2} is 0 mL/m² or more to 10 mL/m² or less in the Bristow method described in No. 51 “Paper and Paperboard, Liquid Absorbency Test Method” of Paper and Pulp Test Method by JAPAN TAPPI. In the present disclosure, the recording medium satisfying the conditions for the water absorption amount is defined as “low to non-absorbing recording medium”. A recording medium (glossy paper, mat paper or the like) for ink jet recording, which includes a coating layer (ink receiving layer) formed of an inorganic particle or plain paper having no coating layer is “absorbing recording medium” having a water absorption amount of more than 10 mL/m².

Examples of the low to non-absorbing recording medium include a plastic film, a recording medium in which a plastic film is adhered to the recording surface of a base material, and a recording medium in which a resin coating layer is provided on the recording surface of a base material containing cellulose pulp. Among these, a plastic film is preferable, and a recording medium in which a resin coating layer is provided on the recording surface of a base material containing cellulose pulp is also preferable. Further, the recording medium in the present specification denotes not a transfer body but a recording medium which is a target on which an image is recorded as a recorded material.

### First Reaction Liquid

The recording method of the present disclosure includes a reaction liquid applying step (first reaction liquid applying step) of applying an aqueous reaction liquid that contains a reactant reacting with an aqueous ink, to the recording medium. Hereinafter, each component and the like used in the first reaction liquid will be described in detail.

### Reactant

The first reaction liquid aggregates components (components containing an anionic group, such as a resin, a surfactant and a self-dispersible pigment) in the ink by reacting with the ink when coming into contact with the ink and contains a reactant. Due to the presence of the reactant, the state of presence of the components containing an anionic group in the ink is destabilized when the ink and the reactant come into contact with each other in the recording medium, and thus the aggregation of the ink can be promoted. The first reaction liquid contains a water-soluble cationic resin which is a reactant. The content (% by mass) of the reactant containing a water-soluble cationic resin in the first reaction liquid is preferably 0.1% by mass or more to 40.0% by mass or less and more preferably 1.0% by mass or more to 20.0% by mass or less with respect to the total mass of the reaction liquid. The reactant may be used alone or in combination of two or more kinds thereof. Examples of other reactants include a polyvalent metal salt and an organic acid. It is preferable that the first reaction liquid further contain at least one reactant selected from the group consisting of a polyvalent metal salt and an organic acid.

### Water-Soluble Cationic Resin

The water-soluble cationic resin (hereinafter, also simply referred to as a cationic resin) is a reactant that has a cation moiety in the structure of the resin and aggregates the pigment in the ink. Examples of the cationic resin include a resin having a structure of primary to tertiary amines and a resin having a structure of a quaternary ammonium salt. Among these, a resin having a structure of a quaternary ammonium salt is preferable as the cationic resin of the first reaction liquid. Specific examples thereof include a resin having a structure of vinylamine, allylamine, vinylimidazole, vinylpyridine, dimethylaminoethyl methacrylate, ethyleneimine, guanidine, diallyldimethylammonium chloride or an alkylamine/epichlorohydrin condensate. In order to increase the solubility in the reaction liquid, the cationic resin and an acidic compound can be used in combination or the cationic resin can be subjected to a quaternization treatment.

The weight-average molecular weight of the cationic resin is preferably 500 or more to 50000 or less. The weight-average molecular weight of the cationic resin can be measured, for example, as a value in terms of polystyrene measured by gel permeation chromatography. Here, the weight-average molecular weight of the cationic resin is more preferably 30000 or less. In a case where the weight-average molecular weight of the cationic resin is more than 30000, since a large aggregate is formed when the cationic resin reacts with the ink, the cationic resin is unlikely to move, and thus the adhesiveness of the image cannot be sufficiently obtained in some cases. The content (% by mass) of the cationic resin in the first reaction liquid is preferably 0.1% by mass or more to 10.0% by mass or less and more preferably 0.1% by mass or more to 5.0% by mass or less with respect to the total mass of the reaction liquid.

Further, the cationic degree (meq/g) of the cationic resin is preferably 3 meq/g or more to 7 meq/g or less. When the cationic degree is less than 3 meq/g, the effect of aggregating the pigment and the like is weakened, and thus embedding of the ink in the image cannot be sufficiently suppressed in some cases. Meanwhile, when the cationic degree is more than 7 meq/g, the effect of aggregating the pigment and the like is extremely strong, unevenness is likely to occur between the recording medium and the image, and thus the adhesiveness of the image cannot be sufficiently obtained in some cases. The cationic degree is an index showing the degree of cationicity of a resin and expressed by the number of millimoles of the cationic group per 1 g of the resin, and the number of moles of the cationic group increases as the cationic degree increases.

The cationic degree of the cationic resin can be measured by colloid titration at 25° C. In the examples described below, the cationic degree of the cationic resin is measured by colloid titration using an automatic potentiometric titrator (trade name, “AT-510”, manufactured by Kyoto Electronics Manufacturing Co., Ltd.) and a 1/400N potassium polyvinyl sulfate liquid (manufactured by FUJIFILM Corporation) as a titration reagent. The aqueous liquid of the cationic resin used for titration may be prepared by dissolving the cationic resin appropriately extracted from the first reaction liquid in water.

### Polyvalent Metal Salt

The polyvalent metal salt is a compound formed of a divalent or higher valent metal ion (polyvalent metal ion) and an anion. Since the polyvalent metal salt is dissociated in the aqueous reaction liquid to generate a polyvalent metal ion, the polyvalent metal salt is a reactant that aggregates the pigment in the ink.

Examples of the polyvalent metal ion constituting the polyvalent metal salt include divalent metal ions such as Ca²⁺, Cu²⁺, Ni²⁺, Mg²⁺, Sr²⁺, Ba²⁺ and Zn²⁺, and trivalent metal ions such as Fe³⁺, Cr³⁺, Y³⁺ and A³⁺. Among these, from the viewpoint of the reactivity of the metal ion and the ink, it is preferable to use at least one metal ion selected from the group consisting of Ca²⁺ and Mg²⁺.

In order to allow the first reaction liquid to contain the polyvalent metal ion, a water-soluble polyvalent metal salt (may be a hydrate) formed by bonding a polyvalent metal ion and an anion to each other can be used.

Examples of the anion include inorganic anions such as Cl⁻, Br⁻, I⁻, CIO⁻, CIO₂⁻, CIO₃⁻, CIO₄⁻, NO₂⁻, NO₃⁻, SO₄²⁻, CO₃²⁻, HCO₃⁻, PO₄³⁻, HPO₄²⁻ and H₂PO₄⁻, and organic anions such as HCOO⁻, (COO⁻)₂, COOH(COO⁻), CH₃COO⁻, CH₃CH(OH)COO⁻, C₂H₄(COO⁻)₂, C₆H₅COO⁻, C₆H₄(COO⁻)₂ and CH₃SO₃⁻. Among these, it is preferable that the polyvalent metal salt of the reaction liquid be at least one compound selected from the group consisting of calcium lactate (combination of Ca²⁺ and CH₃CH(OH)COO⁻) and magnesium sulfate (combination of Mg²⁺ and SO₄²⁻). The reactivity with the ink can be further improved by using the above-described polyvalent metal salt.

In a case where the polyvalent metal ion is used as the reactant, the content (% by mass) thereof in terms of the polyvalent metal salt in the first reaction liquid is preferably 1.0% by mass or more to 20.0% by mass or less with respect to the total mass of the reaction liquid. In the present specification, “content (% by mass) of the polyvalent metal salt” in the reaction liquid in a case where the polyvalent metal salt is a hydrate denotes “content (% by mass) of an anhydride of the polyvalent metal salt” excluding water as a hydrate.

### Organic Acid

The reaction liquid containing an organic acid has a buffer capacity in an acidic region (pH of less than 7.0 and preferably 2.0 to 5.0) and thus efficiently aggregates anionic groups of the components present in the ink in the form of an acid. Examples of the organic acid include a monocarboxylic acid such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid or coumaric acid and a salt thereof, a dicarboxylic acid such as oxalic acid, malonic acid, succinic acid, glutaric acid, adipic acid, maleic acid, fumaric acid, itaconic acid, sebacic acid, phthalic acid, malic acid or tartaric acid, a salt thereof and a hydrogen salt thereof, a tricarboxylic acid such as citric acid or trimellitic acid, a salt thereof and a hydrogen salt thereof, and a tetracarboxylic acid such as pyromellitic acid, a salt thereof and a hydrogen salt thereof.

In a case where the organic acid is used as the reactant, it is preferable to use a polyvalent carboxylic acid from the viewpoint of effectively suppressing embedding of the ink in the image. That is, it is preferable that the organic acid used as the reactant be a polyvalent carboxylic acid. When a monovalent carboxylic acid is used as the reactant, a monovalent carboxylic acid with low water solubility is likely to precipitate due to evaporation or the like of the liquid component of the ink until the ink is applied to the recording medium, and the effect of making an anionic group in the form of an acid cannot be sufficiently exhibited. As a result, embedding of the ink in the image cannot be sufficiently suppressed in some cases. Further, even when a monovalent carboxylic acid with high water solubility is used as the reactant, since the monovalent carboxylic acid has high volatility, the effect of making an anionic group in the form of an acid cannot be sufficiently exhibited, similar to the description above. As a result, embedding of the ink in the image cannot be sufficiently suppressed in some cases.

The acid dissociation constant (pKa) of the organic acid at 25° C. is preferably 5.0 or less.

The pKa denotes the degree of easiness in dissociation of a proton of an acid. In a case where an organic acid has a plurality of anionic groups (carboxylic acid groups), the organic acid has a plurality of pKa values, and it can be said that the amount of the organic acid to be dissociated in the reaction liquid depends on a first acid dissociation constant (pKa₁). Therefore, in the present specification, the acid dissociation constant in a case where an organic acid has a plurality of anionic groups denotes the first acid dissociation constant. When the organic acid has a pKa of more than 5.0, the effect of aggregating the pigment is weakened, and thus embedding of the ink in the image cannot be sufficiently suppressed in some cases. The content (% by mass) of the organic acid in the first reaction liquid is preferably 1.0% by mass or more to 10.0% by mass or less and more preferably 1.0% by mass or more to 5.0% by mass or less with respect to the total mass of the reaction liquid.

### Aqueous Medium

The first reaction liquid is an aqueous reaction liquid containing at least water as an aqueous medium. The aqueous medium used in the reaction liquid can contain a water-soluble organic solvent described below, which can be contained in the ink.

### Other Components

The first reaction liquid may contain various other components as necessary. Examples of the other components include those that are the same as the other components described below, which can be contained in the ink (the first ink and the second ink).

### Physical Properties of Reaction Liquid

The first reaction liquid that can be suitably used for the recording method of the present disclosure is an aqueous reaction liquid to be applied to the ink jet method. Therefore, it is preferable that the physical property values thereof be appropriately controlled from the viewpoint of the reliability. Specifically, the surface tension of the reaction liquid at 25° C. is preferably 20 mN/m or more to 60 mN/m or less. Further, the viscosity of the reaction liquid at 25° C. is 1.0 mPa·s or more to 10.0 mPa·s or less. The pH of the reaction liquid at 25° C. is preferably 5.0 or more to 9.5 or less and more preferably 6.0 or more to 9.0 or less.

The viscosity of the mixed liquid 1-1 obtained by mixing the first reaction liquid and the first ink at a mass ratio of 7:100 is higher than the viscosity of the mixed liquid 2-1 obtained by mixing the second reaction liquid and the first ink at a mass ratio of 7:100. The viscosity of the mixed liquid 1-2 obtained by mixing the first reaction liquid and the second ink at a mass ratio of 7:100 is higher than the viscosity of the mixed liquid 2-2 obtained by mixing the second reaction liquid and the second ink at a mass ratio of 7:100. From the viewpoint of controlling the reactivity, it is preferable that the viscosity of the mixed liquid 1-1 obtained by mixing the first reaction liquid and the first ink at a mass ratio of 7:100 be twice or more of the viscosity of the mixed liquid 2-1 obtained by mixing the second reaction liquid and the first ink at a mass ratio of 7:100. The second reaction liquid, the first ink and the second ink will be described in detail below. The viscosity of the mixed liquid may be measured, by adding the reaction liquid and the ink at the above-described mass ratio to an appropriate container such as a beaker under a temperature condition of 25° C. and sufficiently stirring the mixture. In a case where the reaction can sufficiently proceed, the mixture may be stirred by any method of using a stirrer or the like. In the examples described below, the viscosity during mixing of the mixture is measured by mixing the liquid and stirring the mixture for 10 seconds at a memory 10 using a vortex mixer (trade name “TUBE MIXER TM-2N”, manufactured by AS ONE Corporation). The viscosity can be measured by using a rotational viscometer, and an E-type viscometer (trade name “RE-80L”, manufactured by Toki Sangyo Co., Ltd.) in the examples described below.

The viscosity of the mixed liquid can be adjusted, for example, by the content of the reactant, the content of the cationic resin, the molecular weight of the cationic resin, the cationic degree of the cationic resin, the acid value of the organic acids used in combination or the like. Further, the viscosity of the mixed liquid can also be adjusted by the inks used in combination. For example, in a case where the ink contains a self-dispersible pigment, the viscosity of the mixed liquid can be adjusted by the viscosity of the carboxylic acid group to be bonded to the particle surface of the pigment directly or through another atomic group. Further, in a case where the ink contains a resin-dispersed pigment, the viscosity of the mixed liquid can be adjusted by the acid value of the resin dispersant to be used, the ratio between the pigment and the resin dispersant or the like. Further, the viscosity of the mixed liquid can be also adjusted by the acid value and the content of the resin particle, and the acid value and the content of the water-soluble resin which may be added to the ink. In order to increase the viscosity during mixing of the mixture, the size of the aggregate generated by the reaction may be increased, or the amount of the aggregate may be increased. In order to achieve this, a method of increasing the density of the anionic group (carboxylic acid group) of the self-dispersible pigment, increasing the acid value of the resin dispersant of the resin-dispersed pigment, increasing the acid value of the resin particle or increasing the acid value of the water-soluble resin may be used.

### Second Reaction Liquid

The recording method of the present disclosure includes a reaction liquid applying step (second reaction liquid applying step) of applying the aqueous reaction liquid that contains a reactant reacting with the aqueous ink, to the recording medium. Hereinafter, each component used in the second reaction liquid will be described in detail.

### Reactant

The second reaction liquid aggregates components (components containing an anionic group, such as a resin, a surfactant and a self-dispersible pigment) in the ink by reacting with the ink when coming into contact with the ink and contains a reactant. Due to the presence of the reactant, the state of presence of the components containing an anionic group in the ink is destabilized when the ink and the reactant come into contact with each other in the recording medium, and thus the aggregation of the ink can be promoted.

The second reaction liquid can use a reactant appropriately selected from those exemplified as the reactant that can be used in the first reaction liquid described above. The content (% by mass) of the reactant in the second reaction liquid is preferably 0.1% by mass or more to 40.0% by mass or less with respect to the total mass of the reaction liquid.

It is preferable that the second reaction liquid contain a water-soluble cationic resin. In a case where the second reaction liquid also contains a water-soluble cationic resin, the followability to the first ink layer formed of the first reaction liquid and the first ink is improved, and thus the adhesiveness of the image can be further improved. Further, in the case where the second reaction liquid contains a water-soluble cationic resin, it is preferable that the content (% by mass) of the cationic resin in the first reaction liquid be more than the content (% by mass) of the cationic resin in the second reaction liquid. Here, a difference between the content (% by mass) of the cationic resin in the first reaction liquid and the content (% by mass) of the cationic resin in the second reaction liquid is preferably 1.0% or more. When the difference in the content of the cationic resin between the first reaction liquid and the second reaction liquid is 1.0% or more, a difference in reactivity between the first reaction liquid and the second reaction liquid is further increased, and embedding of the ink in the image can be further suppressed.

Further, it is preferable that the content (% by mass) of the reactant in the first reaction liquid be more than the content (% by mass) of the reactant in the second reaction liquid. Here, a difference between the content (% by mass) of the reactant in the first reaction liquid and the content (% by mass) of the reactant in the second reaction liquid is preferably 1.0% or more.

### Aqueous Medium

The second reaction liquid is an aqueous reaction liquid containing at least water as an aqueous medium. The aqueous medium used in the reaction liquid can contain a water-soluble organic solvent described below, which can be contained in the ink (the first ink and the second ink).

### Other Components

The second reaction liquid may contain various other components as necessary. Examples of the other components include those that are the same as the other components described below, which can be contained in the ink (the first ink and the second ink).

### Physical Properties of Reaction Liquid

The second reaction liquid that can be suitably used for the recording method of the present disclosure is an aqueous reaction liquid to be applied to the ink jet method. Therefore, it is preferable that the physical property values thereof be appropriately controlled from the viewpoint of the reliability. Specifically, the surface tension of the reaction liquid at 25° C. is preferably 20 mN/m or more to 60 mN/m or less. Further, the viscosity of the reaction liquid at 25° C. is 1.0 mPa·s or more to 10.0 mPa·s or less. The pH of the reaction liquid at 25° C. is preferably 5.0 or more to 9.5 or less and more preferably 6.0 or more to 9.0 or less.

It is preferable that the surface tension of the second reaction liquid be more than the surface tension of the first reaction liquid. In a case where the surface tension of the first reaction liquid is more than the surface tension of the second reaction liquid, the probability of contact between the first reaction liquid and the first ink is decreased, and thus the reactivity of the first reaction liquid with the first ink cannot be sufficiently obtained in some cases. As a result, embedding of the ink in the image cannot be sufficiently suppressed in some cases. Here, a difference between the surface tension of the second reaction liquid and the surface tension of the first reaction liquid is preferably 1.0 mN/m or more. The surface tension can be measured by a surface tensiometer using a plate method.

### First Ink

The first ink used for the recording method of the present disclosure is an ink jet aqueous ink containing a pigment. Hereinafter, each component constituting the first ink will be described in detail.

### Coloring Material

The first ink contains a pigment as a coloring material. The content (% by mass) of the pigment in the ink is preferably 0.1% by mass or more to 20.0% by mass or less and more preferably 1.0% by mass or more to 15.0% by mass or less with respect to the total mass of the ink.

Specific examples of the pigment include an inorganic pigment such as carbon black or titanium oxide, and an organic pigment such as azo, phthalocyanine, quinacridone, isoindolinone, imidazolone, diketopyrrolopyrrole or dioxazine. The pigment may be used alone or in combination of two or more kinds thereof.

As a pigment dispersion method, a resin-dispersed pigment formed of a resin as a dispersant or a self-dispersible pigment in which a hydrophilic group is bonded to the particle surface of the pigment can be used. Further, a resin-bonded pigment in which an organic group containing a resin is chemically bonded to the particle surface of the pigment, a microcapsule pigment in which the particle surface of the pigment is coated with a resin, or the like can be used. Among these, pigments using different dispersion methods can also be used in combination. Among these, it is preferable to use a resin-dispersed pigment in which a resin as a dispersant is physically adsorbed on the particle surface of the pigment without using a resin-bonded pigment or a microcapsule pigment.

It is preferable to use a resin dispersant that can disperse the pigment in an aqueous medium using the action of an anionic group as the resin dispersant for dispersing the pigment in an aqueous medium. Resins containing an anionic group can be used as the resin dispersant, and the following resins and particularly water-soluble resins among the resins can be used. The content (% by mass) of the pigment in the ink is preferably 0.3 times or more to 10.0 times or less in terms of the mass ratio with respect to the content of the resin dispersant.

As the self-dispersible pigment, a pigment in which an anionic group such as a carboxylic acid group, a sulfonic acid group or a phosphonic acid group is bonded to the particle surface of the pigment directly or through another atomic group (—R—) can be used. The anionic group may be of an acid type or a salt type and may be in a dissociable state partially or entirely in a case where the anionic group is of a salt type. Examples of the cation serving as a counter ion include an alkali metal cation, aluminum and organic aluminum in the case where the anionic group is of a salt type. Specific examples of the other atomic groups (—R—) include a linear or branched alkylene group having 1 to 12 carbon atoms, an arylene group such as a phenylene group or a naphthylene group, a carbonyl group, an imino group, an amide group, a sulfonyl group, an ester group and an ether group. Further, a group obtained by combining these groups may be used.

It is preferable that the pigment of the first ink be titanium oxide. General-purpose titanium oxide serving as a coloring material of an ink jet aqueous ink tends to have a particle diameter larger than those of other pigments for producing whiteness. Therefore, it is considered that in a case where titanium oxide is used as the pigment of the first ink, embedding of the ink in the image can be suppressed due to the size of the particle diameter when the second ink is applied in an overlapping manner.

An inorganic oxide such as titanium oxide reacts with a water molecule constituting an aqueous medium in an aqueous ink so that a hydroxy group (hereinafter, also referred to as “surface hydroxy group”) is generated on the surface thereof. Therefore, the ink jet aqueous ink is typically used in a state of being subjected to a surface treatment with an inorganic oxide such as alumina or silica in order to further improve the storage stability of the ink while the generated surface hydroxy group is utilized. The surface hydroxy group of the titanium oxide particle has properties unique to the inorganic oxide corresponding to the inorganic compound used for the surface treatment, and the isoelectric point, which is an index of strength as an acid, varies depending on the kind of inorganic compound.

Therefore, the titanium oxide itself is an inorganic oxide, the surface of the titanium oxide particle exhibits the properties of the inorganic oxide corresponding to the inorganic compound used in the surface treatment, and the surface charge of the titanium oxide particle strongly depends on the pH of the aqueous medium, the kind of the surface treatment agent and the amount of the surface treatment agent to be used.

The titanium oxide is a white pigment, and three crystal forms, which are a rutile type, an anatase type and a brookite type, are present. Among these, rutile type titanium oxide is preferable. Examples of an industrial method of producing titanium oxide include a sulfuric acid method and a chlorine method, and the titanium oxide used in the present disclosure may be produced by any production method.

The surface of the titanium oxide may be coated (surface treatment) with an inorganic oxide or an organic substance. Among such titanium oxides, it is preferable to use titanium oxide subjected to a surface treatment with alumina or silica. The surface treatment is expected to suppress photocatalytic activity performance and improve dispersibility. In the present specification, “alumina” is a general term for an oxide of aluminum such as aluminum oxide. Further, in the present specification, “silica” is a general term for silicon dioxide or a substance formed of silicon dioxide. The most of alumina and silica covering the titanium oxide are present in the form of silicon dioxide and aluminum oxide.

Examples of a method of measuring the proportion of alumina and silica in the titanium oxide particle, that is, the coating amount of the alumina and silica include quantitative analysis of aluminum and a silicon element using inductively coupled plasma (ICP) emission spectrometry. In this case, the proportion thereof can be calculated by assuming that the atoms covering the surface of the titanium oxide are all oxides and converting the obtained value of aluminum and silicon into the oxides thereof, that is, alumina and silica.

Examples of the surface treatment method for the titanium oxide include a wet treatment and a dry treatment. For example, titanium oxide is dispersed in a liquid medium and reacts with surface treatment agents such as sodium aluminate and sodium silicate to carry out a surface treatment so that the titanium oxide has desired characteristics that can also be adjusted by appropriately changing the ratio between these surface treatment agents. An inorganic oxide such as zinc oxide or zirconia and an organic substance such as a polyol can be used for the surface treatment in addition to the alumina and silica as long as the effects of the present disclosure are not impaired.

### Resin

The first pigment can contain a resin. An image with improved abrasion resistance can be recorded by using the ink containing a resin. (i) The resin can be added to the ink to stabilize the dispersion state of the pigment, that is, to serve as a resin dispersant or an assistant thereof. (ii) Further, the resin can be added to the ink to improve various characteristics of an image to be recorded.

The content (% by mass) of the resin in the first ink is preferably 0.1% by mass or more to 20.0% by mass or less and more preferably 0.5% by mass or more to 15.0% by mass or less with respect to the total mass of the ink. Examples of the form of the resin include a block copolymer, a random copolymer, a graft copolymer and a combination thereof. Further, the resin may be a water-soluble resin that can be dissolved in an aqueous medium or a resin particle that is dispersed in an aqueous medium. The resin may be used alone or in combination of two or more kinds thereof. Among these, it is preferable that the first ink further contain a water-soluble resin. It is considered that the reactivity of the ink with the first reaction liquid can be improved and the adhesiveness to the recording medium can be enhanced by allowing the first ink to contain a water-soluble resin.

In a case where the first ink contains a resin particle, the reactivity of the first ink can be adjusted, for example, by the density of the anionic group of the resin particle or the acid value of the resin constituting the resin particle. Further, the viscosity during mixing of a mixture is increased, for example, by a method of increasing the density of the carboxylic acid group of the resin particle or a method of increasing the acid value of the resin particle.

### Composition of Resin

Examples of the resin include an acrylic resin, a urethane-based resin and an olefin-based resin. Among these, an acrylic resin or a urethane-based resin is preferable, and an acrylic resin formed of a unit derived from (meth)acrylic acid or (meth)acrylate is more preferable.

An acrylic resin having a hydrophilic unit and a hydrophobic unit as constituent units is preferable as the acrylic resin. Among such examples, a resin having a hydrophilic unit derived from (meth)acrylic acid and a hydrophobic unit derived from at least one selected from the group consisting of a monomer having an aromatic ring and a (meth)acrylic acid ester-based monomer is preferable. Particularly, a resin having a hydrophilic unit derived from (meth)acrylic acid and a hydrophobic unit derived from at least one selected from the group consisting of styrene and α-methylstyrene is preferable. These resins are likely to interact with a pigment and thus can be suitably used as a resin dispersant for dispersing the pigment.

The hydrophilic unit is a unit containing a hydrophilic group such as an anionic group. The hydrophilic group can be formed by polymerizing a hydrophilic monomer containing a hydrophilic group. Specific examples of the hydrophilic monomer containing a hydrophilic group include an acidic monomer containing a carboxylic acid group such as (meth)acrylic acid, itaconic acid, maleic acid or fumaric acid, and an anionic monomer such as an anhydride or a salt of the acidic monomer. Examples of a cation constituting a salt of the acidic monomer include an ion such as lithium, sodium, potassium, ammonium or organic ammonium. The hydrophobic unit is a unit containing no hydrophilic group such as an anionic group. The hydrophobic unit can be formed, for example, by containing no hydrophilic group such as an anionic group and polymerizing a hydrophobic monomer. Specific examples of the hydrophobic monomer include a monomer having an aromatic ring such as styrene, α-methylstyrene or benzyl (meth)acrylate, and a (meth)acrylic acid ester-based monomer such as methyl (meth)acrylate, butyl (meth)acrylate and 2-ethylhexyl (meth)acrylate.

The urethane-based resin can be obtained, for example, by reacting a polyisocyanate with a polyol. Further, the urethane-based resin may be obtained by further reacting a chain extender. Examples of the olefin-based resin include polyethylene and polypropylene.

### Properties of Resin

In the present specification, the expression “resin is water-soluble” denotes that the resin is present in an aqueous medium in a state where a particle having a particle diameter that can be measured by a dynamic light scattering method is not formed in a case where the resin is neutralized with an alkali equivalent to the acid value. Whether the resin is water-soluble can be determined by the following method. First, a liquid (resin solid content: 10% by mass) containing a resin neutralized with an alkali (sodium hydroxide, potassium hydroxide or the like) equivalent to the acid value is prepared. Next, the prepared liquid is diluted to 10 times (on a volume basis) with pure water to prepare a sample liquid.

Further, in a case where the particle diameter of the resin in the sample liquid is measured by a dynamic light scattering method, the resin can be determined as a water-soluble resin when a particle having a particle diameter is not measured. The measurement here can be performed by setting SetZero to 30 seconds, the number of times of measurement to three times and the measurement time to 180 seconds. Further, a particle size analyzer (for example, trade name “UPA-EX150”, manufactured by NIKKISO CO., Ltd.) using a dynamic light scattering method can be used as a particle size distribution measuring device.

It goes without saying that the particle size distribution measuring device to be used, the measurement conditions and the like are not limited to the description above.

The acid value of the water-soluble resin is preferably 100 mgKOH/g or more to 250 mgKOH/g or less. The weight-average molecular weight of the water-soluble resin is preferably 3000 or more to 15000 or less.

The acid value of the resin constituting the resin particle is preferably 5 mgKOH/g or more to 100 mgKOH/g or less. The weight-average molecular weight of the resin constituting the resin particle is preferably 1000 or more to 3000000 or less and more preferably 100000 or more to 3000000 or less. The volume-based cumulative 50% particle diameter (D50) of the resin particle measured by the dynamic light scattering method is preferably 50 nm or more to 500 nm or less. The volume-based cumulative 50% particle diameter of the resin particle is the particle diameter that is 50% in a case of integration from the small particle diameter side based on the total volume of the measured particles in the particle diameter integration curve. The volume-based cumulative 50% particle diameter of the resin particle can be measured with a particle size analyzer using a dynamic light scattering method under the measurement conditions described above. The glass transition temperature of the resin particle is preferably 40° C. or higher to 120° C. or lower and more preferably 50° C. or higher to 100° C. or lower. The glass transition temperature (° C.) of the resin particle can be measured by using a differential scanning calorimeter (DSC). The resin particle does not necessarily contain a coloring material.

### Wax Particle

The first ink can contain a particle formed of a wax (wax particle). An image with further improved abrasion resistance can be recorded by using the ink containing the wax particle. The wax in the present specification may be a composition blended with a component other than the wax or may be the wax itself. The wax particle may be dispersed with a dispersant such as a surfactant or a water-soluble resin. The wax may be used alone or in combination of two or more kinds thereof. The content (% by mass) of the wax particle in the first ink is preferably 0.1% by mass or more to 10.0% by mass or less and more preferably 1.0% by mass or more to 5.0% by mass or less with respect to the total mass of the ink.

The wax in a broad sense is an ester of a water-insoluble higher monohydric or dihydric alcohol and a fatty acid and includes an animal-based wax and a vegetable-based wax, but excludes oils and fats. The wax in a broad sense include fats having a high melting point, a mineral-based wax, a petroleum-based wax and a blended substance or a modified substance of various waxes. In the recording method of the present disclosure, the wax in a broad sense can be used without particular limitation. The wax in a broad sense can be classified into a natural wax, a synthetic wax, a blended substance (blended wax) thereof and a modified substance (modified wax) thereof.

Examples of the natural wax include an animal-based wax such as beeswax, spermaceti or wool wax (lanolin), a vegetable-based wax such as wood wax, carnauba wax, sugarcane wax, palm wax, candelilla wax or rice wax, a mineral-based wax such as montan wax, and a petroleum-based wax such as paraffin wax, microcrystalline wax or petrolatum. Examples of the synthetic wax include a hydrocarbon-based wax such as Fischer-Tropsch wax or polyolefin wax (such as polyethylene wax or polypropylene wax). The blended wax is a mixture of various waxes. The modified wax is a wax obtained by performing a modification treatment such as oxidation, hydrogenation, alcohol modification, acrylic modification or urethane modification on the various waxes. The above-described wax may be used alone or in combination of two or more kinds thereof. At least one wax selected from the group consisting of microcrystalline wax, Fischer-Tropsch wax, polyolefin wax, paraffin wax, and a modified substance or mixture thereof is preferable as the wax. Among these, a blended substance of a plurality of kinds of waxes is more preferable, and a blended substance of a petroleum-based wax and a synthetic wax is particularly preferable.

It is preferable that the wax be a solid at room temperature (25° C.). The melting point (° C.) of the wax is preferably 40° C. or higher to 120° C. or lower and more preferably 50° C. or higher to 100° C. or lower. The melting point of the wax particle can be measured in conformity with the test method described in 5.3.1 (melting point test method) of JIS K 2235:1991 (petroleum wax). When the test method described in 5.3.2 is used in a case of microcrystalline wax, petrolatum and a mixture of a plurality of kinds of waxes, the melting point can be more accurately measured. The melting point of the wax is likely to be affected by characteristics such as the molecular weight (the melting point increases as the molecular weight increases), the molecular structure (the melting point increases in a case of a linear molecular structure and decreases in a case of a branched molecular structure), the crystallinity (the melting point increases as the crystallinity is high) and the density (the melting point increases as the density increases). Therefore, a wax having a desired melting point can be obtained by controlling the above-described characteristics. The melting point of the wax in the ink can be measured, for example, in conformity with the above-described test method after the ink is subjected to an ultracentrifugation treatment and the separated wax is washed and dried.

### Aqueous Medium

The first ink used for the recording method of the present disclosure is an aqueous ink containing at least water as an aqueous medium. The first ink can contain water or an aqueous medium which is a mixed solvent of water and a water-soluble organic solvent. Deionized water or ion exchange water is preferably used as water. The content (% by mass) of water in the first ink is preferably 50.0% by mass or more to 95.0% by mass or less with respect to the total mass of the ink. Further, the content (% by mass) of the water-soluble organic solvent in the first ink is preferably 3.0% by mass or more to 50.0% by mass or less with respect to the total mass of the ink. Any water-soluble organic solvent that can be used in an ink jet ink such as alcohols, (poly)alkylene glycols, glycol ethers, nitrogen-containing solvents or sulfur-containing solvents can be used as the water-soluble organic solvent. The water-soluble organic solvent may be used alone or in combination of two or more kinds thereof.

### Other Components

The first ink may contain various other additives as necessary. Examples of the other components include various additives such as an antifoaming agent, a surfactant, a pH adjuster, a viscosity adjuster, a rust inhibitor, a preservative, a fungicide, an antioxidant and a reducing inhibitor. Here, it is preferable that the first ink contain no reactant to be contained in the reaction liquid.

### Physical Properties of Ink

The first ink is an aqueous ink to be applied to the ink jet method. Therefore, it is preferable that the physical properties thereof be appropriately controlled from the viewpoint of reliability. Specifically, the surface tension of the ink at 25° C. is preferably 20 mN/m or more to 60 mN/m or less. Further, the viscosity of the ink at 25° C. is preferably 1.0 mPa·s or more to 10.0 mPa·s or less. The pH of the ink at 25° C. is preferably 7.0 or more to 9.5 or less and more preferably 8.0 or more to 9.5 or less.

### Second Ink

The second ink used for the recording method of the present disclosure is an ink jet aqueous ink containing at least one particulate substance selected from the group consisting of a pigment and a resin particle. That is, the second ink may be an ink that does not contain a pigment, but contains a resin particle. Such an ink is also referred to as a clear ink. Hereinafter, each component constituting the second ink will be described in detail.

### Coloring Material

It is preferable that the second ink contain a pigment as a coloring material. The content (% by mass) of the pigment in the second ink is preferably 0.1% by mass or more to 20.0% by mass or less and more preferably 1.0% by mass or more to 15.0% by mass or less with respect to the total mass of the ink.

Specific examples of the pigment include an inorganic pigment such as carbon black or titanium oxide, and an organic pigment such as azo, phthalocyanine, quinacridone, isoindolinone, imidazolone, diketopyrrolopyrrole or dioxazine. The pigment may be used alone or in combination of two or more kinds thereof.

The pigment can be used by being appropriately selected from those exemplified as the pigment that can be used in the first ink. Further, the properties thereof can also be determined in the same manner as those for the pigment that can be applied to the first ink. Among these, it is preferable that the pigment as the particulate substance of the second ink be at least one selected from the group consisting of carbon black and an organic pigment. That is, it is preferable that the first ink be a white ink and the second ink be a colored ink (non-white ink). Further, the second ink may contain no pigment as described above. Therefore, the first ink may be a white ink and the second ink may be a clear ink containing no pigment.

### Resin

The second ink contains at least one selected from the group consisting of a pigment and a resin particle. It is preferable that the second ink further contain a water-soluble resin that can be dissolved in the aqueous medium. In this case, the acid value of the water-soluble resin in the first ink is preferably higher than the acid value of the water-soluble resin in the second ink. Here, a difference between the acid value of the water-soluble resin in the first ink and the acid value of the water-soluble resin in the second ink is preferably 50 mgKOH/g or more. The acid value of the resin can be measured based on JIS K-0070.

The resin can be used by being appropriately selected from those exemplified as the resin that can be used in the first ink. Further, the properties thereof can also be determined in the same manner as those for the resin that can be applied to the first ink.

### Wax Particle

The second ink can contain a particle formed of a wax (wax particle). An image with further improved abrasion resistance can be recorded by using the ink containing the wax particle. The wax in the present specification may be a composition blended with a component other than the wax or may be the wax itself. The wax particle may be dispersed with a dispersant such as a surfactant or a water-soluble resin. The wax may be used alone or in combination of two or more kinds thereof. The content (% by mass) of the wax particle in the second ink is preferably 0.1% by mass or more to 10.0% by mass or less and more preferably 1.0% by mass or more to 5.0% by mass or less with respect to the total mass of the ink.

The wax can be used by being appropriately selected from those exemplified as the wax that can be used in the first ink. Further, the properties thereof can also be determined in the same manner as those for the wax that can be applied to the first ink.

### Aqueous Medium

The second ink used for the recording method of the present disclosure is an aqueous ink containing at least water as an aqueous medium. The second ink can contain water or an aqueous medium which is a mixed solvent of water and a water-soluble organic solvent. Deionized water or ion exchange water is preferably used as water. The content (% by mass) of water in the second ink is preferably 50.0% by mass or more to 95.0% by mass or less with respect to the total mass of the ink. Further, the content (% by mass) of the water-soluble organic solvent in the second ink is preferably 2.0% by mass or more to 40.0% by mass or less with respect to the total mass of the ink. Any water-soluble organic solvent that can be used in an ink jet ink such as alcohols, (poly)alkylene glycols, glycol ethers, nitrogen-containing solvents or sulfur-containing solvents can be used as the water-soluble organic solvent. The water-soluble organic solvent may be used alone or in combination of two or more kinds thereof.

### Other Components

The second ink may contain various other additives as necessary. Examples of the other components include various additives such as an antifoaming agent, a surfactant, a pH adjuster, a viscosity adjuster, a rust inhibitor, a preservative, a fungicide, an antioxidant and a reducing inhibitor. Here, it is preferable that the second ink contain no reactant to be contained in the reaction liquid.

### Physical Properties of Ink

The second ink is an aqueous ink to be applied to the ink jet method. Therefore, it is preferable that the physical properties thereof be appropriately controlled from the viewpoint of reliability. Specifically, the surface tension of the ink at 25° C. is preferably 20 mN/m or more to 60 mN/m or less. Further, the viscosity of the ink at 25° C. is preferably 1.0 mPa·s or more to 10.0 mPa·s or less. The pH of the ink at 25° C. is preferably 7.0 or more to 9.5 or less and more preferably 8.0 or more to 9.5 or less.

### EXAMPLES

Hereinafter, the present disclosure will be described in more detail with reference to examples and comparative examples. The present disclosure is not limited to the following examples unless the gist thereof is overstepped. In regard to the component amount, “parts” and “%” are on a mass basis unless otherwise specified.

### Measurement of Physical Property Value

### Viscosity of Mixed Liquid

The viscosity when each reaction liquid and each ink were mixed at a mass ratio of 7:100 was measured as follows. First, the reaction liquid and the ink were mixed at the above-described mixing ratio. Further, the viscosity was measured by stirring the mixture for 10 seconds at a memory 10 using a vortex mixer (trade name “TUBE MIXER TM-2N”, manufactured by AS ONE Corporation). The viscosity was measured by using an E-type viscometer (trade name “RE-80L”, manufactured by Toki Sangyo Co., Ltd.).

### Acid Value of Resin

The acid value of the resin was measured by a titration method based on JIS K-0070. 0.5 g to 2.0 g of the resin was precisely weighed and used as a sample of a measurement target. The sample was put into a 50.0 mL beaker, 25.0 mL of a mixed liquid containing tetrahydrofuran and ethanol at a volume ratio of 2:1 was added thereto, and the sample was dissolved therein. The titration was performed by potentiometric titration using a 0.1 mol/L potassium hydroxide ethanol liquid as a titrant, and the amount of the titrant used was set to S (mL). Further, a blank containing no sample was subjected to titration in the same manner as described above, and the amount of the potassium hydroxide ethanol liquid was set to B (mL). An automatic titration device (trade name “COM-2500”, manufactured by HIRANUMA Co., Ltd.) was used as a measuring device. The acid value was calculated from S and B obtained above according to the following equation. Here, f represents a factor (potency) of the potassium hydroxide ethanol liquid, and M (g) represents a precisely weighed value of the sample.

Acid value[mgKOH/g]=(S−B)×f×5.61/M

### Preparation of Reaction Liquid

Respective components (unit: %) listed in Tables 1 to 6 were mixed and sufficiently stirred, and filtered through a cellulose acetate filter (manufactured by ADVANTEC CO., LTD.) having a pore size of 3.0 μm under pressure, thereby preparing a first reaction liquid and a second reaction liquid. In Tables 1 to 6, “CATIOMASTER PDT-2”, “CATIOMASTER PD-7” and “CATIOMASTER PD-30” are trade names of amine-epichlorohydrin condensation type polymer aqueous liquids (manufactured by Yokkaichi Chemica Company Limited). Further, “Capstone FS3100” is a trade name of a fluorine-based nonionic surfactant (manufactured by LEHVOSS Group), and “PROXEL GXL(S)” is a trade name of a preservative (manufactured by Arch Chemicals, Inc.). “ACETYLENOL E60” is a trade name of a non-ionic surfactant (manufactured by Kawaken Fine Chemicals Co., Ltd.). “PAS-2401” is a trade name of an aqueous liquid of a diallylmethylethylammonium ethyl sulfate/sulfur dioxide copolymer (manufactured by NITTOBO MEDICAL CO., LTD.). “PAS-A-5” and “PAS-H-1L” are trade names of aqueous liquids of diallyldimethylammonium chloride (manufactured by NITTOBO MEDICAL CO., LTD.). “Polyquat 40u05NV” is a trade name of an aqueous liquid of diallyldimethylammonium chloride (manufactured by KATPOL CHEMIE GmbH). “PAA-HCL-01” is a trade name of an aqueous liquid of an allylamine hydrochloride polymer (manufactured by NITTOBO MEDICAL CO., LTD.). “PAS-92” is a trade name of an aqueous liquid of a diallylamine hydrochloride/sulfur dioxide copolymer (manufactured by NITTOBO MEDICAL CO., LTD.). “PAS-M-1L” is a trade name of an aqueous liquid of a dimethyldiallylamine acetate polymer (manufactured by NITTOBO MEDICAL CO., LTD.). “PROXEL GXL(S)” is a trade name of a preservative (manufactured by Arch Chemicals, Inc.). Further, a surface tension y (mN/m) of the reaction liquid is a value of a static surface tension measured at 25° C. by using a Wilhelmy type surface tensiometer (trade name “Automatic Surface Tensiometer CBVP-Z”, manufactured by Kyowa Interface Science Co., Ltd.).

The details of the cationic resins used for preparing the first reaction liquid and the second reaction liquid are described below.
CATIOMASTER PDT-2 (trade name): manufactured by Yokkaichi Chemical Company Limited, weight-average molecular weight: 1000, cationic degree: 7 meq/g, content of resin: 60.0%, quaternary ammonium salt
CATIOMASTER PD-7 (trade name): manufactured by Yokkaichi Chemical Company Limited, weight-average molecular weight: 5000, cationic degree: 7 meq/g, content of resin: 50.0%, quaternary ammonium salt
CATIOMASTER PD-30 (trade name): manufactured by Yokkaichi Chemical Company Limited, weight-average molecular weight: 9000, cationic degree: 7 meq/g, content of resin: 50.0%, quaternary ammonium salt
PAS-2401 (trade name): manufactured by NITTOBO MEDICAL CO., LTD., weight-average molecular weight: 2000, cationic degree: 2 meq/g, content of resin: 25.0%, quaternary ammonium salt
PAS-A-5 (trade name): manufactured by NITTOBO MEDICAL CO., LTD., weight-average molecular weight: 4000, cationic degree: 3 meq/g, content of resin: 40.0%, quaternary ammonium salt
PAS-H-1L (trade name): manufactured by NITTOBO MEDICAL CO., LTD., weight-average molecular weight: 8500, cationic degree: 5 meq/g, content of resin: 28.0%, quaternary ammonium salt
Polyquat 40u05NV (trade name): manufactured by KATPOL CHEMIE GmbH, weight-average molecular weight: 4000, cationic degree: 6 meq/g, content of resin: 40.0%, quaternary ammonium salt
PAA-HCL-01 (trade name): manufactured by NITTOBO MEDICAL CO., LTD., weight-average molecular weight: 1600, cationic degree: 9 meq/g, content of resin: 33.0%, primary amine
PAS-92 (trade name): manufactured by NITTOBO MEDICAL CO., LTD., weight-average molecular weight: 5000, cationic degree: 5 meq/g, content of resin: 20.0%, secondary amine
PAS-M-IL (trade name): manufactured by NITTOBO MEDICAL CO., LTD., weight-average molecular weight: 5000, cationic degree: 5 meq/g, content of resin: 25.0%, tertiary amine

TABLE 1
Composition and characteristics of first reaction liquid

| | First reaction liquid | | | | | | | | |
|---|---|---|---|---|---|---|---|---|---|
| | 1 | 2 | 3 | 4 | 5 | 6 | 7 | 8 | 9 |
| CATIOMASTER PD-7 | 6.0 | | | | | | | 8.0 | 6.0 |
| CATIOMASTER PDT-2 | | 5.0 | | | | | | | |
| CATIOMASTER PD-30 | | | 6.0 | | | | | | |
| PAS-2401 | | | | 12.0 | | | | | |
| PAS-A-5 | | | | | 7.5 | | | | |
| PAS-H-1L | | | | | | 10.7 | | | |
| Polyquat 40u05NV | | | | | | | 7.5 | | |
| PAA-HCL-01 | | | | | | | | | |
| PAS-92 | | | | | | | | | |
| PAS-M-1L | | | | | | | | | |
| Magnesium sulfate heptahydrate | 4.0 | 4.0 | 4.0 | 4.0 | 4.0 | 4.0 | 4.0 | 4.0 | |
| Calcium lactate pentahydrate | | | | | | | | | 3.5 |
| Calcium acetate monohydrate | | | | | | | | | |
| Succinic acid | | | | | | | | | |
| Malic acid | | | | | | | | | |
| Acetic acid | | | | | | | | | |
| 1,2-Butanediol | 15.0 | 15.0 | 15.0 | 15.0 | 15.0 | 15.0 | 15.0 | 15.0 | 15.0 |
| ACETYLENOL E60 | 1.0 | 1.0 | 1.0 | 1.0 | 1.0 | 1.0 | 1.0 | 1.0 | 1.0 |
| PROXEL GXL(S) | 0.2 | 0.2 | 0.2 | 0.2 | 0.2 | 0.2 | 0.2 | 0.2 | 0.2 |
| Ion exchange water | 73.8 | 74.8 | 73.8 | 67.8 | 72.3 | 69.1 | 72.3 | 71.8 | 74.3 |
| Surface tension γ(mN/m) | 27 | 27 | 27 | 27 | 27 | 27 | 27 | 27 | 27 |
| Content (%) of cationic resin | 3.0 | 3.0 | 3.0 | 3.0 | 3.0 | 3.0 | 3.0 | 4.0 | 3.0 |
| Content of (%) reactant | 5.0 | 5.0 | 5.0 | 5.0 | 5.0 | 4.9 | 5.0 | 6.0 | 5.5 |

TABLE 2
Composition and characteristics of first reaction liquid

| | First reaction liquid | | | | | | | | |
|---|---|---|---|---|---|---|---|---|---|
| | 10 | 11 | 12 | 13 | 14 | 15 | 16 | 17 | 18 |
| CATIOMASTER PD-7 | 6.0 | 6.0 | 6.0 | 6.0 | 6.0 | 6.0 | 6.0 | | |
| CATIOMASTER PDT-2 | | | | | | | | | |
| CATIOMASTER PD-30 | | | | | | | | | |
| PAS-2401 | | | | | | | | | |
| PAS-A-5 | | | | | | | | | |
| PAS-H-1L | | | | | | | | | |
| Polyquat 40u05NV | | | | | | | | | |
| PAA-HCL-01 | | | | | | | | 9.1 | |
| PAS-92 | | | | | | | | | 15.0 |
| PAS-M-1L | | | | | | | | | |
| Magnesium sulfate heptahydrate | | 6.0 | | | | | 2.0 | 4.0 | 4.0 |
| Calcium lactate pentahydrate | | | | | | | | | |
| Calcium acetate monohydrate | 3.0 | | | | | | | | |
| Succinic acid | | | 2.0 | | | 3.0 | 1.0 | | |
| Malic acid | | | | 2.0 | | | | | |
| Acetic acid | | | | | 2.0 | | | | |
| 1,2-Butanediol | 15.0 | 15.0 | 15.0 | 15.0 | 15.0 | 15.0 | 15.0 | 15.0 | 15.0 |
| ACETYLENOL E60 | 1.0 | 1.0 | 1.0 | 1.0 | 1.0 | 1.0 | 1.0 | 1.0 | 1.0 |
| PROXEL GXL(S) | 0.2 | 0.2 | 0.2 | 0.2 | 0.2 | 0.2 | 0.2 | 0.2 | 0.2 |
| Ion exchange water | 74.8 | 71.8 | 75.8 | 75.8 | 75.8 | 74.8 | 74.8 | 70.7 | 64.8 |
| Surface tension γ(mN/m) | 27 | 27 | 27 | 27 | 27 | 27 | 27 | 27 | 27 |
| Content (%) of cationic resin | 3.0 | 3.0 | 3.0 | 3.0 | 3.0 | 3.0 | 3.0 | 3.0 | 3.0 |
| Content of (%) reactant | 5.7 | 5.9 | 5.0 | 5.0 | 5.0 | 6.0 | 5.0 | 5.0 | 5.0 |

TABLE 3
Composition and characteristics of first reaction liquid

| | First reaction liquid | | | | | | | | |
|---|---|---|---|---|---|---|---|---|---|
| | 19 | 20 | 21 | 22 | 23 | 24 | 25 | 26 | 27 |
| CATIOMASTER PD-7 | | 6.0 | 1.0 | 10.0 | 6.0 | | 1.0 | | |
| CATIOMASTER PDT-2 | | | | | | | | | |
| CATIOMASTER PD-30 | | | | | | | | | |
| PAS-2401 | | | | | | | | | |
| PAS-A-5 | | | | | | | | 1.3 | |
| PAS-H-1L | | | | | | | | | |
| Polyquat 40u05NV | | | | | | | | | |
| PAA-HCL-01 | | | | | | | | | |
| PAS-92 | | | | | | | | | |
| PAS-M-1L | 12.0 | | | | | 8.0 | | | |
| Magnesium sulfate heptahydrate | 4.0 | 4.0 | 6.0 | | 2.0 | | 4.0 | 4.0 | 6.0 |
| Calcium lactate pentahydrate | | | | | | | | | |
| Calcium acetate monohydrate | | | | | | | | | |
| Succinic acid | | | | | | | | | |
| Malic acid | | | | | | | | | |
| Acetic acid | | | | | | | | | |
| 1,2-Butanediol | 15.0 | 15.0 | 15.0 | 15.0 | 15.0 | 15.0 | 15.0 | 15.0 | 15.0 |
| ACETYLENOL E60 | 1.0 | 0.5 | 1.0 | 1.0 | 1.0 | 0.5 | 1.0 | 1.0 | 1.0 |
| PROXEL GXL(S) | 0.2 | 0.2 | 0.2 | 0.2 | 0.2 | 0.2 | 0.2 | 0.2 | 0.2 |
| Ion exchange water | 67.8 | 74.3 | 76.8 | 73.8 | 75.8 | 76.3 | 78.8 | 78.6 | 77.8 |
| Surface tension γ(mN/m) | 27 | 29 | 27 | 27 | 27 | 29 | 27 | 27 | 27 |
| Content (%) of cationic resin | 3.0 | 3.0 | 0.5 | 5.0 | 3.0 | 2.0 | 0.5 | 0.5 | 0.0 |
| Content of (%) reactant | 5.0 | 5.0 | 3.4 | 5.0 | 4.0 | 2.0 | 2.5 | 2.5 | 2.9 |

TABLE 4
Composition and characteristics of second reaction liquid

| | Second reaction liquid | | | | | | | | |
|---|---|---|---|---|---|---|---|---|---|
| | 1 | 2 | 3 | 4 | 5 | 6 | 7 | 8 | 9 |
| CATIOMASTER PD-7 | 1.0 | | | | | | | 0.6 | 1.0 |
| CATIOMASTER PDT-2 | | 0.8 | | | | | | | |
| CATIOMASTER PD-30 | | | 1.0 | | | | | | |
| PAS-2401 | | | | 2.0 | | | | | |
| PAS-A-5 | | | | | 1.3 | | | | |
| PAS-H-1L | | | | | | 1.8 | | | |
| Polyquat 40u05NV | | | | | | | 1.3 | | |
| PAA-HCL-01 | | | | | | | | | |
| PAS-92 | | | | | | | | | |
| PAS-M-1L | | | | | | | | | |
| Magnesium sulfate heptahydrate | 4.0 | 4.0 | 4.0 | 4.0 | 4.0 | 4.0 | 4.0 | 4.0 | |
| Calcium lactate pentahydrate | | | | | | | | | 3.5 |
| Calcium acetate monohydrate | | | | | | | | | |
| Succinic acid | | | | | | | | | |
| Malic acid | | | | | | | | | |
| Acetic acid | | | | | | | | | |
| 1,2-Butanediol | 15.0 | 15.0 | 15.0 | 15.0 | 15.0 | 15.0 | 15.0 | 15.0 | 15.0 |
| ACETYLENOL E60 | 0.5 | 0.5 | 0.5 | 0.5 | 0.5 | 0.5 | 0.5 | 0.5 | 0.5 |
| PROXEL GXL(S) | 0.2 | 0.2 | 0.2 | 0.2 | 0.2 | 0.2 | 0.2 | 0.2 | 0.2 |
| Ion exchange water | 79.3 | 79.5 | 79.3 | 78.3 | 79.1 | 78.5 | 79.1 | 79.7 | 79.8 |
| Surface tension γ(mN/m) | 29 | 29 | 29 | 29 | 29 | 29 | 29 | 29 | 29 |
| Content (%) of cationic resin | 0.5 | 0.5 | 0.5 | 0.5 | 0.5 | 0.5 | 0.5 | 0.3 | 0.5 |
| Content of (%) reactant | 2.5 | 2.5 | 2.5 | 2.5 | 2.5 | 2.5 | 2.5 | 2.3 | 3.0 |

TABLE 5
Composition and characteristics of second reaction liquid

| | Second reaction liquid | | | | | | | | |
|---|---|---|---|---|---|---|---|---|---|
| | 10 | 11 | 12 | 13 | 14 | 15 | 16 | 17 | 18 |
| CATIOMASTER PD-7 | 1.0 | 1.0 | 1.0 | 1.0 | 1.0 | 1.0 | 1.0 | | 1.0 |
| CATIOMASTER PDT-2 | | | | | | | | | |
| CATIOMASTER PD-30 | | | | | | | | | |
| PAS-2401 | | | | | | | | | |
| PAS-A-5 | | | | | | | | | |
| PAS-H-1L | | | | | | | | | |
| Polyquat 40u05NV | | | | | | | | | |
| PAA-HCL-01 | | | | | | | | | |
| PAS-92 | | | | | | | | | |
| PAS-M-1L | | | | | | | | | |
| Magnesium sulfate heptahydrate | | 2.0 | | | | | 2.0 | 4.0 | 4.0 |
| Calcium lactate pentahydrate | | | | | | | | | |
| Calcium acetate monohydrate | 3.0 | | | | | | | | |
| Succinic acid | | | 2.0 | | | 1.0 | 1.0 | | |
| Malic acid | | | | 2.0 | | | | | |
| Acetic acid | | | | | 2.0 | | | | |
| 1,2-Butanediol | 15.0 | 15.0 | 15.0 | 15.0 | 15.0 | 15.0 | 15.0 | 15.0 | 15.0 |
| ACETYLENOL E60 | 0.5 | 0.5 | 0.5 | 0.5 | 0.5 | 0.5 | 0.5 | 0.5 | 0.8 |
| PROXEL GXL(S) | 0.2 | 0.2 | 0.2 | 0.2 | 0.2 | 0.2 | 0.2 | 0.2 | 0.2 |
| Ion exchange water | 80.3 | 81.3 | 81.3 | 81.3 | 81.3 | 82.3 | 80.3 | 80.3 | 79.1 |
| Surface tension γ(mN/m) | 29 | 29 | 29 | 29 | 29 | 29 | 29 | 29 | 28 |
| Content (%) of cationic resin | 0.5 | 0.5 | 0.5 | 0.5 | 0.5 | 0.5 | 0.5 | 0.0 | 0.5 |
| Content of (%) reactant | 3.2 | 1.5 | 2.5 | 2.5 | 2.5 | 1.5 | 2.5 | 2.0 | 2.5 |

TABLE 6
Composition and characteristics of second reaction liquid

| | Second reaction liquid | | | | | | | | |
|---|---|---|---|---|---|---|---|---|---|
| | 19 | 20 | 21 | 22 | 23 | 24 | 25 | 26 | 27 |
| CATIOMASTER PD-7 | 1.0 | 4.0 | 2.0 | 2.0 | | 1.0 | | 6.0 | 10.0 |
| CATIOMASTER PDT-2 | | | | | 3.0 | | | | |
| CATIOMASTER PD-30 | | | | | | | | | |
| PAS-2401 | | | | | | | | | |
| PAS-A-5 | | | | | | | | | |
| PAS-H-1L | | | | | | | | | |
| Polyquat 40u05NV | | | | | | | | | |
| PAA-HCL-01 | | | | | | | | | |
| PAS-92 | | | | | | | | | |
| PAS-M-1L | | | | | | | | | |
| Magnesium sulfate heptahydrate | 4.0 | 4.0 | 4.0 | | | 8.0 | | 4.0 | |
| Calcium lactate pentahydrate | | | | | | | | | |
| Calcium acetate monohydrate | | | | | | | | | |
| Succinic acid | | | | | | | | | |
| Malic acid | | | | | | | | | |
| Acetic acid | | | | | 3.2 | | 5.0 | | |
| 1,2-Butanediol | 15.0 | 15.0 | 15.0 | 15.0 | 15.0 | 15.0 | 15.0 | 15.0 | 15.0 |
| ACETYLENOL E60 | 1.0 | 0.5 | 0.5 | 0.5 | 0.5 | 0.5 | 1.0 | 0.5 | 1.0 |
| PROXEL GXL(S) | 0.2 | 0.2 | 0.2 | 0.2 | 0.2 | 0.2 | 0.2 | 0.2 | 0.2 |
| Ion exchange water | 78.8 | 76.3 | 78.3 | 82.3 | 78.1 | 75.3 | 78.8 | 74.3 | 73.8 |
| Surface tension γ(mN/m) | 27 | 29 | 29 | 29 | 29 | 29 | 27 | 29 | 27 |
| Content (%) of cationic resin | 0.5 | 2.0 | 1.0 | 1.0 | 1.8 | 0.5 | 0.0 | 3.0 | 5.0 |
| Content of (%) reactant | 2.5 | 4.0 | 3.0 | 1.0 | 5.0 | 4.4 | 5.0 | 5.0 | 5.0 |

### Preparation of Pigment Dispersion Liquid

### Pigment Dispersion Liquid 1

A styrene-ethyl acrylate-acrylic acid copolymer (resin 1) with an acid value of 100 mgKOH/g and a weight-average molecular weight of 8000 was prepared. 20.0 parts of the resin 1 was neutralized with potassium hydroxide in an amount equimolar to the acid value thereof, and an appropriate amount of pure water was added thereto to prepare an aqueous liquid of the resin 1 in which the content of the resin (solid content) was 20.0%, 15.0 parts of a pigment (carbon black), 22.5 parts of the aqueous liquid of the resin 1 and 62.5 parts of pure water were mixed to obtain a mixture. The obtained mixture and 200 parts of zirconia beads having a diameter of 0.3 mm were placed in a batch type vertical sand mill (manufactured by AIMEX Co., Ltd.) and dispersed for 5 hours while being cooled with water. Coarse particles were removed by centrifugation, and the resultant was filtered under pressure through a cellulose acetate filter (manufactured by ADVANTEC CO., LTD.) having a pore size of 3.0 μm, thereby preparing a pigment dispersion liquid 1 in which the content of the pigment was 15.0% and the content of the resin dispersant (resin 1) was 4.5%.

### Pigment Dispersion Liquid 2

A pigment dispersion liquid 2 in which the content of the pigment was 15.0% and the content of the resin dispersant (resin 2) was 4.5% was prepared by the same procedures as those for the pigment dispersion liquid 1 described above except that the resin 1 was changed to the resin (resin 2) with an acid value of 150 mgKOH/g and a weight-average molecular weight of 7000.

### Pigment Dispersion Liquid 3

A liquid obtained by dissolving 5.0 g of concentrated hydrochloric acid in 5.5 g of water was cooled to 5° C., and 1.5 g of 4-aminophthalic acid was added thereto. A container containing this liquid was placed in an ice bath, and a liquid obtained by dissolving 0.9 g of sodium nitrite in 9.0 g of ion exchange water at 5° C. was added to the liquid while the liquid was stirred and maintained at a temperature of 10° C. or lower. The liquid was stirred for 15 minutes, 6.0 g of carbon black was added thereto while the liquid was stirred, and the resulting liquid was further stirred for 15 minutes, thereby obtaining a slurry. The obtained slurry was filtered through filter paper (trade name “Standard Filter Paper No. 2” manufactured by ADVANTEC CO., LTD.), and the particles were sufficiently washed with water and dried in an oven at 110° C. Thereafter, sodium ions were replaced with potassium ions by an ion exchange method, thereby obtaining a self-dispersible pigment in which a —C₆H₃—(COOK)₂ group was bonded to the particle surface of the pigment. The content of the pigment was adjusted by adding an appropriate amount of pure water, thereby obtaining a pigment dispersion liquid 3 in which the content of the pigment was 15.0%.

### Pigment Dispersion Liquid 4

A pigment dispersion liquid 4 in which the content of the pigment was 15.0% and the content of the resin dispersant (resin 1) was 4.5% was prepared by the same procedures as those for the pigment dispersion liquid 1 described above except that the pigment was changed to C.I. Pigment Blue 15:3.

### Pigment Dispersion Liquid 5

A pigment dispersion liquid 5 in which the content of the pigment was 15.0% and the content of the resin dispersant (resin 1) was 4.5% was prepared by the same procedures as those for the pigment dispersion liquid 1 described above except that the pigment was changed to C.I. Pigment Red 122.

### Pigment Dispersion Liquid 6

A pigment dispersion liquid 6 in which the content of the pigment was 15.0% and the content of the resin dispersant (resin 1) was 4.5% was prepared by the same procedures as those for the pigment dispersion liquid 1 described above except that the pigment was changed to C.I. Pigment Yellow 74.

### Pigment Dispersion Liquid 7

40.0 parts of rutile type titanium oxide (trade name “TITANIX JR-403”, surface treatment: alumina and silica), 1.2 parts of 3-(methoxy (polyoxyethylene) 9-12) propyltrimethoxysilane and ion exchange water in an amount set such that the total amount of components reached 100.0 parts were mixed and pre-dispersed using a homogenizer. Thereafter, the mixture was subjected to a dispersion treatment with a paint shaker at 25° C. for 12 hours using zirconia beads having a diameter of 0.5 mm. The zirconia beads were filtered, and an appropriate amount of ion exchange water was added to the resulting mixture as necessary, thereby preparing a pigment dispersion liquid 7 in which the content of the pigment (titanium oxide particle) was 40.0%.

### Pigment Dispersion Liquid 8

A pigment dispersion liquid 8 in which the content of the pigment (titanium oxide particle) was 40.0% was prepared by the same procedures as those for the pigment dispersion liquid 7 described above except that the pigment was changed to rutile type titanium oxide (trade name “TITANIX JR-800”, surface treatment: alumina and silica).

### Production of Resin Particle

### Aqueous Dispersion Liquid of Resin Particle 1

A four-necked flask provided with a stirrer, a reflux cooling device and a nitrogen gas introduction pipe was charged with 78.8 parts of ion exchange water and 0.2 parts of potassium persulfate (polymerization initiator), nitrogen gas was introduced thereto, and the mixture was stirred and heated to 80° C. A mixture of 2.3 parts of methacrylic acid, 90.0 parts of butyl methacrylate and 90.0 parts of methyl methacrylate, and an ethylene glycol monobutyl ether liquid of 1.3 parts of t-butyl peroxide (polymerization initiator) were added dropwise to the mixture over 2 hours. The mixture was aged for 2 hours and cooled to 25° C. An appropriate amount of potassium hydroxide and an appropriate amount of ion exchange water were added to the mixture to adjust the pH thereof to 8.5, thereby obtaining an aqueous dispersion liquid of a resin particle 1 in which the content of the resin (solid content) was 30.0%. The acid value of the resin constituting the resin particle 1 was 8.2 mgKOH/g.

### Aqueous Dispersion Liquid of Resin Particle 2

An aqueous dispersion liquid of a resin particle 2 in which the content of the resin (solid content) was 30.0% was obtained by the same procedures as those for the aqueous dispersion liquid of the resin particle 1 described above except that the amount of methacrylic acid was set to 1.6 parts, the amount of butyl methacrylate was set to 95.0 parts, and the amount of methyl methacrylate was set to 95.0 parts. The acid value of the resin constituting the resin particle 2 was 5.4 mgKOH/g.

### Preparation of Wax Particle

25.0 parts of commercially available Fischer-Tropsch wax (trade name “FT-0165”, manufactured by NIPPON SEIRO CO., LTD., melting point of 73° C.) and 5.0 parts of polyoxyethylene (15) cetyl ether were mixed, and the temperature and the pressure were appropriately adjusted to disperse the wax. An appropriate amount of ion exchange water was added thereto for dilution, thereby obtaining an aqueous dispersion liquid of a wax particle 1 in which the content of the wax particle was 30.0%.

### Preparation of Ink

Respective components (unit: %) listed in Tables 7 to 10 were mixed and sufficiently stirred, and filtered through a cellulose acetate filter (manufactured by ADVANTEC CO., LTD.) having a pore size of 3.0 μm under pressure, thereby preparing a first ink and a second ink. Here, the inks obtained by using the pigment dispersion liquids 7 and 8 were filtered through a cellulose acetate filter (manufactured by ADVANTEC CO., LTD.) having a pore size of 5.0 μm under pressure. In Tables 7 to 10, “JONCRYL 683” is a trade name of an acrylic resin (manufactured by BASF Japan Ltd., weight-average molecular weight of about 8000, acid value of 160 mgKOH/g). “JONCRYL 819” is a trade name of an acrylic resin (manufactured by BASF Japan Ltd., weight-average molecular weight of about 15000, acid value of 75 mgKOH/g).

TABLE 7
Composition of first ink

| | First ink | | | | | | | |
|---|---|---|---|---|---|---|---|---|
| | 1 | 2 | 3 | 4 | 5 | 6 | 7 | 8 |
| Pigment dispersion liquid 1 | | | | | | | | 23.3 |
| Pigment dispersion liquid 2 | | | | | | | | |
| Pigment dispersion liquid 4 | | | | | | | | |
| Pigment dispersion liquid 5 | | | | | | | | |
| Pigment dispersion liquid 6 | | | | | | | | |
| Pigment dispersion liquid 7 | 37.5 | | 37.5 | 37.5 | 43.8 | 37.5 | 37.5 | |
| Pigment dispersion liquid 8 | | 37.5 | | | | | | |
| Aqueous dispersion liquid of resin particle 1 | 33.3 | 33.3 | | 33.3 | 33.3 | 41.7 | 33.3 | 33.3 |
| Aqueous dispersion liquid of resin particle 2 | | | 33.3 | | | | | |
| JONCRYL 683 | 0.5 | 0.5 | 0.5 | | 0.5 | 0.5 | 0.8 | 0.5 |
| JONCRYL 819 | | | | 0.5 | | | | |
| 1,2-Butanediol | 15.0 | 15.0 | 15.0 | 15.0 | 15.0 | 15.0 | 15.0 | 15.0 |
| ACETYLENOL E60 | 0.5 | 0.5 | 0.5 | 0.5 | 0.5 | 0.5 | 0.5 | 0.5 |
| PROXEL GXL(S) | 0.2 | 0.2 | 0.2 | 0.2 | 0.2 | 0.2 | 0.2 | 0.2 |
| Ion exchange water | 13.0 | 13.0 | 13.0 | 13.0 | 6.7 | 4.6 | 12.7 | 27.2 |

TABLE 8
Composition of first ink

| | First ink | | | | | | | |
|---|---|---|---|---|---|---|---|---|
| | 9 | 10 | 11 | 12 | 13 | 14 | 15 | 16 |
| Pigment dispersion liquid 1 | | | | | | | | 23.3 |
| Pigment dispersion liquid 2 | 23.3 | | | | | | | |
| Pigment dispersion liquid 4 | | 23.3 | | | | | | |
| Pigment dispersion liquid 5 | | | 23.3 | | | | | |
| Pigment dispersion liquid 6 | | | | 23.3 | | | | |
| Pigment dispersion liquid 7 | | | | | 37.5 | 37.5 | 37.5 | |
| Pigment dispersion liquid 8 | | | | | | | | |
| Aqueous dispersion liquid of resin particle 1 | 33.3 | 33.3 | 33.3 | 33.3 | 33.3 | 33.3 | 33.3 | 16.7 |
| Aqueous dispersion liquid of resin particle 2 | | | | | | | | |
| JONCRYL 683 | 0.5 | 0.5 | 0.5 | 0.5 | 0.2 | 0.15 | | |
| JONCRYL 819 | | | | | | | | |
| 1,2-Butanediol | 15.0 | 15.0 | 15.0 | 15.0 | 15.0 | 15.0 | 15.0 | 15.0 |
| ACETYLENOL E60 | 0.5 | 0.5 | 0.5 | 0.5 | 0.5 | 0.5 | 0.5 | 0.5 |
| PROXEL GXL(S) | 0.2 | 0.2 | 0.2 | 0.2 | 0.2 | 0.2 | 0.2 | 0.2 |
| Ion exchange water | 27.2 | 27.2 | 27.2 | 27.2 | 13.3 | 13.35 | 13.5 | 44.3 |

TABLE 9
Composition of second ink

| | Second ink | | | | | | |
|---|---|---|---|---|---|---|---|
| | 1 | 2 | 3 | 4 | 5 | 6 | 7 |
| Pigment dispersion liquid 1 | 23.3 | | | | | | 23.3 |
| Pigment dispersion liquid 2 | | 23.3 | | | | | |
| Pigment dispersion liquid 3 | | | 23.3 | | | | |
| Pigment dispersion liquid 4 | | | | 23.3 | | | |
| Pigment dispersion liquid 5 | | | | | 23.3 | | |
| Pigment dispersion liquid 6 | | | | | | 23.3 | |
| Aqueous dispersion liquid of wax particle 1 | 11.7 | 11.7 | 11.7 | 11.7 | 11.7 | 11.7 | 11.7 |
| Aqueous dispersion liquid of resin particle 1 | | | | | | | 33.3 |
| Aqueous dispersion liquid of resin particle 2 | 33.3 | 33.3 | 33.3 | 33.3 | 33.3 | 33.3 | |
| JONCRYL 683 | | | | | | | |
| JONCRYL 819 | 0.1 | 0.1 | 0.1 | 0.1 | 0.1 | 0.1 | 0.1 |
| 1,2-Butanediol | 15.0 | 15.0 | 15.0 | 15.0 | 15.0 | 15.0 | 15.0 |
| ACETYLENOL E60 | 0.5 | 0.5 | 0.5 | 0.5 | 0.5 | 0.5 | 0.5 |
| PROXEL GXL(S) | 0.2 | 0.2 | 0.2 | 0.2 | 0.2 | 0.2 | 0.2 |
| Ion exchange water | 16.0 | 16.0 | 16.0 | 16.0 | 16.0 | 16.0 | 16.0 |

TABLE 10
Composition of second ink

| | Second ink | | | | | |
|---|---|---|---|---|---|---|
| | 8 | 9 | 10 | 11 | 12 | 13 |
| Pigment dispersion liquid 1 | 23.3 | 16.7 | 23.3 | 23.3 | | 23.3 |
| Pigment dispersion liquid 2 | | | | | | |
| Pigment dispersion liquid 3 | | | | | | |
| Pigment dispersion liquid 4 | | | | | | |
| Pigment dispersion liquid 5 | | | | | | |
| Pigment dispersion liquid 6 | | | | | | |
| Aqueous dispersion liquid of wax particle 1 | 11.7 | 11.7 | 11.7 | 11.7 | 11.7 | 11.7 |
| Aqueous dispersion liquid of resin particle 1 | | | | | | |
| Aqueous dispersion liquid of resin particle 2 | 33.3 | 33.3 | 26.7 | 33.3 | 33.3 | 33.3 |
| JONCRYL 683 | 0.1 | | | | | |
| JONCRYL 819 | | 0.1 | 0.1 | 0.05 | 0.1 | |
| 1,2-Butanediol | 15.0 | 15.0 | 15.0 | 15.0 | 15.0 | 15.0 |
| ACETYLENOL E60 | 0.5 | 0.5 | 0.5 | 0.5 | 0.5 | 0.5 |
| PROXEL GXL(S) | 0.2 | 0.2 | 0.2 | 0.2 | 0.2 | 0.2 |
| Ion exchange water | 15.9 | 22.6 | 22.6 | 15.95 | 39.3 | 16.0 |

### Evaluation

Cartridges were filled with each of the prepared reaction liquids and prepared inks, and set in an ink jet recording device (trade name “imagePROGRAF PRO-2000”, manufactured by CANON INC.) equipped with a recording head ejecting the ink using thermal energy. In this recording device, a heating device for drying a recording medium, to which the reaction liquid and the ink had been applied, by blowing air thereto was installed in a position downstream of the recording head in the conveyance direction of the recording medium. The surface temperature of the recording medium when heated by the heating device was set to 80° C. The recording was carried out in an environment of a temperature of 25° C. and a relative humidity of 50%. In the present examples, an image recorded under a condition that one ink droplet in an amount of 4.0 ng is applied to a unit area of 1/1200 inches× 1/1200 inches is defined as a recording duty of 100%. A solid image with a size of 5 cm×5 cm in which the recording duty of the first reaction liquid was 10% and the recording duty of the first ink was 100% was recorded under the conditions listed in Tables 11 and 12. Thereafter, a solid image with a size of 5 cm×5 cm in which the recording duty of the second reaction liquid was 10% and the recording duty of the second ink was 100% was recorded such that this image overlapped with the solid image. A polyethylene terephthalate (PET) film (trade name “Ultra-Transparent PET Film GIY-0305”, manufactured by Lintec Corporation, water absorption amount from start of contact to 30 msec^{1/2} in Bristow method is in a range of 0 mL/m² or more to 10 mL/m² or less) was used as the recording medium. Here, in Example 67, highly transparent polyvinyl chloride (trade name, “3M Scotchcal Clear Graphic Film IJ8150”, manufactured by 3M Japan Limited, water absorption amount from start of contact to 30 msec^{1/2} in Bristow method is in a range of 0 mL/m² or more to 10 mL/m² or less) was used as the recording medium. Further, in Comparative Examples 7 and 8, high-quality paper (trade name “55PW8KCOC”, manufactured by Lintec Corporation, water absorption amount from start of contact to 30 msec^{1/2} in Bristow method is 12 mL/m²) was used as the recording medium. Further, the recording was performed by applying the first reaction liquid, the first ink, the second reaction liquid and the second ink in this order in the examples except for Comparative Example 5, and the recording was performed by applying the first reaction liquid, the second reaction liquid, the first ink and the second ink in this order in Comparative Example 5.

In Example 2, accommodating units communicating with the reaction liquid applying device 1201 and the ink applying device 1202 of the ink jet recording device 100 having the configuration shown in FIG. 3 were respectively filled with the reaction liquid and the first ink of the kinds listed in Table 11 without using the above-described ink jet recording device. Further, accommodating units communicating with the reaction liquid applying device 5201 and the ink applying device 5202 of the ink jet recording device 100 having the configuration shown in FIG. 3 were respectively filled with the reaction liquid and the second ink of the kinds listed in Table 11. A solid image with a size of 5 cm×5 cm in which the recording duty of the first reaction liquid was 10% and the recording duty of the first ink was 100% was recorded using the ink jet recording device 100. A difference in time from the application of the reaction liquid to the application of the ink was adjusted to 500 milliseconds by adjusting the conveyance speed of the conveyance member 1300. A solid image with a size of 5 cm×5 cm in which the recording duty of the second reaction liquid was 10% and the recording duty of the second ink was 100% was recorded 5 seconds after the application of the first reaction liquid such that this image overlapped with the solid image. In the present disclosure, “AA”, “A” and “B” are in acceptable levels, and “C” is in an unacceptable level according to the evaluation criteria in each item described below. The evaluation conditions and the evaluation results are listed in Tables 11 and 12. In the present examples, since the application of the ink and the reaction liquid onto the unit area was performed by relative scanning of the recording head and the recording medium carried out once or a plurality of times, the number of times of the relative scanning is listed in the columns of “number of recording passes” in Tables 11 and 12.

### Suppression of Embedding of Second Ink

### Case of Second Ink Containing Pigment

The brightness L* was measured in a case where the second ink contained carbon black in the ink of the obtained image, and the chroma saturation C* was measured in a case where the second ink contained a pigment other than carbon black. L* and C* are based on a color difference display method defined by CIE and measured by using a spectrodensitometer (trade name “FD-7”, manufactured by KONICA MINOLTA JAPAN, INC.). In order to equalizing the conditions, highly transparent polyvinyl chloride (trade name, “3M Scotchcal Clear Graphic Film IJ8150”, manufactured by 3M Japan Limited) was placed under the recording medium on which the image had been recorded. L* and C* were also measured for the image recorded using the second ink and the second reaction liquid. A difference in L* or C* was calculated, and the suppression of embedding of the second ink was evaluated according to the following evaluation criteria.
AA: The difference in L* or C* was 3 or less.
A: The difference in L* or C* was more than 3 to 5 or less.
B: The difference in L* or C* was more than 5 to 10 or less.
C: The difference in L* or C* was more than 10.

### Case of Second Ink Containing No Pigment

A rubbing test in which the surface of the recorded image was reciprocated 150 times under a load of 500 g was performed using an abrasion resistance tester (manufactured by TESTER SANGYO CO., LTD.), which is a rubbing tester II (Gakushin type) in conformity with JIS L 0849 and a white cloth (cotton) for rubbing defined in JIS L 0803. The image after the rubbing test was visually confirmed, and the suppression of embedding of the second ink was evaluated according to the following evaluation criteria.

In a case where scratch marks were not found on the image after reciprocation, this indicates that the second ink was not embedded, but was present on the first ink layer.

AA: Scratch marks were not found on the image after 150 times of reciprocation. A: Scratch marks were found on the image after 150 times of reciprocation, but scratch marks were not found on the image after 100 times of reciprocation.
B: Scratch marks were found on the image after 100 times of reciprocation, but scratch marks were not found on the image after 50 times of reciprocation.
C: Scratch marks were found on the image after 50 times of reciprocation.

### Adhesiveness

Each image was allowed to stand in an environment of a temperature of 25° C. for 1 hour. Thereafter, cellophane tape (trade name “Cellotape (registered trademark)”, manufactured by NICHIBAN Co., Ltd., width of 15 mm) with a length of 3 cm was attached to the surface of the image. The tape was peeled off at a speed of 2 cm/s at an angle of 120 degrees in an attachment direction, peeling of the image was visually confirmed, and the fixing properties of the image were evaluated according to the following evaluation criteria.

A: The image was not attached to the tape, and was also not peeled off.
B: The image was partially attached to the tape, but the background color of the recording medium was not visible in the site where the image was peeled off.
C: The image was partially attached to the tape, and the background color of the recording medium was visible in the site where the image was peeled off.

TABLE 11
Evaluation condition and evaluation result

| | | | | | | | | | | | Evaluation result | |
|---|---|---|---|---|---|---|---|---|---|---|---|---|
| | | Evaluation condition | | | | | | | | | Suppression | |
| | | | | | | | | | | Number | of | |
| | | First | | Second | | Viscosity of | | | | of | embedding | |
| | | reaction | First | reaction | Second | mixed liquid | | | | recording | of second | Adhesiveness |
| | | liquid | ink | liquid | ink | 1-1 | 2-1 | 1-2 | 2-2 | passes | ink | of image |
| Example | 1 | 1 | 1 | 1 | 1 | 16 | 7 | 13 | 5 | 12 | AA | A |
| | 2 | 1 | 1 | 1 | 1 | 16 | 7 | 13 | 5 | 1 | AA | A |
| | 3 | 2 | 1 | 1 | 1 | 15 | 7 | 12 | 5 | 12 | AA | A |
| | 4 | 3 | 1 | 1 | 1 | 17 | 7 | 14 | 5 | 12 | AA | A |
| | 5 | 4 | 1 | 1 | 1 | 15 | 7 | 12 | 5 | 12 | AA | A |
| | 6 | 5 | 1 | 1 | 1 | 16 | 7 | 13 | 5 | 12 | AA | A |
| | 7 | 6 | 1 | 1 | 1 | 17 | 7 | 14 | 5 | 12 | AA | A |
| | 8 | 7 | 1 | 1 | 1 | 16 | 7 | 13 | 5 | 12 | AA | A |
| | 9 | 1 | 1 | 2 | 1 | 16 | 6 | 13 | 4 | 12 | AA | A |
| | 10 | 1 | 1 | 3 | 1 | 16 | 8 | 13 | 6 | 12 | AA | A |
| | 11 | 1 | 1 | 4 | 1 | 16 | 6 | 13 | 4 | 12 | AA | A |
| | 12 | 1 | 1 | 5 | 1 | 16 | 7 | 13 | 5 | 12 | AA | A |
| | 13 | 1 | 1 | 6 | 1 | 16 | 8 | 13 | 6 | 12 | AA | A |
| | 14 | 1 | 1 | 7 | 1 | 16 | 7 | 13 | 5 | 12 | AA | A |
| | 15 | 3 | 1 | 2 | 1 | 17 | 6 | 14 | 4 | 12 | AA | A |
| | 16 | 6 | 1 | 4 | 1 | 17 | 6 | 14 | 4 | 12 | AA | A |
| | 17 | 3 | 1 | 4 | 1 | 17 | 6 | 14 | 4 | 12 | AA | A |
| | 18 | 8 | 1 | 8 | 1 | 17 | 6 | 14 | 4 | 12 | AA | A |
| | 19 | 9 | 1 | 9 | 1 | 16 | 7 | 13 | 5 | 12 | AA | A |
| | 20 | 10 | 1 | 10 | 1 | 16 | 7 | 13 | 5 | 12 | AA | A |
| | 21 | 11 | 1 | 11 | 1 | 17 | 6 | 14 | 4 | 12 | AA | A |
| | 22 | 12 | 1 | 12 | 1 | 16 | 7 | 13 | 5 | 12 | AA | A |
| | 23 | 13 | 1 | 13 | 1 | 16 | 7 | 13 | 5 | 12 | AA | A |
| | 24 | 14 | 1 | 14 | 1 | 15 | 6 | 12 | 4 | 12 | AA | A |
| | 25 | 15 | 1 | 15 | 1 | 17 | 6 | 14 | 4 | 12 | AA | A |
| | 26 | 16 | 1 | 16 | 1 | 16 | 7 | 13 | 5 | 12 | AA | A |
| | 27 | 1 | 2 | 1 | 1 | 15 | 6 | 13 | 5 | 12 | AA | A |
| | 28 | 1 | 3 | 1 | 1 | 15 | 6 | 13 | 5 | 12 | AA | A |
| | 29 | 1 | 4 | 1 | 1 | 15 | 6 | 13 | 5 | 12 | AA | A |
| | 30 | 1 | 5 | 1 | 1 | 17 | 8 | 13 | 5 | 12 | AA | A |
| | 31 | 1 | 6 | 1 | 1 | 17 | 8 | 13 | 5 | 12 | AA | A |
| | 32 | 1 | 7 | 1 | 1 | 17 | 8 | 13 | 5 | 12 | AA | A |
| | 33 | 1 | 1 | 1 | 2 | 16 | 7 | 14 | 6 | 12 | AA | A |
| | 34 | 1 | 1 | 1 | 3 | 16 | 7 | 12 | 4 | 12 | AA | A |
| | 35 | 1 | 1 | 1 | 4 | 16 | 7 | 13 | 5 | 12 | AA | A |
| | 36 | 1 | 1 | 1 | 5 | 16 | 7 | 13 | 5 | 12 | AA | A |

TABLE 12
Evaluation condition and evaluation result

| | | | | | | | | | | | Evaluation result | |
|---|---|---|---|---|---|---|---|---|---|---|---|---|
| | | Evaluation condition | | | | | | | | | Suppression | |
| | | | | | | | | | | Number | of | |
| | | First | | Second | | Viscosity of | | | | of | embedding | |
| | | reaction | First | reaction | Second | mixed liquid | | | | recording | of second | Adhesiveness |
| | | liquid | ink | liquid | ink | 1-1 | 2-1 | 1-2 | 2-2 | passes | ink | of image |
| Example | 37 | 1 | 1 | 1 | 6 | 16 | 7 | 13 | 5 | 12 | AA | A |
| | 38 | 1 | 1 | 1 | 7 | 16 | 7 | 14 | 6 | 12 | AA | A |
| | 39 | 1 | 1 | 1 | 8 | 16 | 7 | 14 | 6 | 12 | AA | A |
| | 40 | 1 | 1 | 1 | 9 | 16 | 7 | 12 | 4 | 12 | AA | A |
| | 41 | 1 | 1 | 1 | 10 | 16 | 7 | 12 | 4 | 12 | AA | A |
| | 42 | 1 | 1 | 1 | 11 | 16 | 7 | 12 | 4 | 12 | AA | A |
| | 43 | 1 | 1 | 1 | 12 | 16 | 7 | 11 | 3 | 12 | AA | A |
| | 44 | 17 | 1 | 1 | 1 | 16 | 7 | 12 | 4 | 12 | A | B |
| | 45 | 18 | 1 | 1 | 1 | 16 | 7 | 12 | 4 | 12 | A | B |
| | 46 | 19 | 1 | 1 | 1 | 16 | 7 | 12 | 4 | 12 | A | B |
| | 47 | 1 | 1 | 17 | 1 | 16 | 6 | 12 | 4 | 12 | A | B |
| | 48 | 1 | 1 | 18 | 1 | 16 | 7 | 13 | 5 | 12 | AA | A |
| | 49 | 1 | 1 | 19 | 1 | 16 | 7 | 13 | 5 | 12 | A | A |
| | 50 | 20 | 1 | 19 | 1 | 16 | 7 | 13 | 5 | 12 | A | B |
| | 51 | 1 | 8 | 1 | 12 | 9 | 4 | 8 | 3 | 12 | B | A |
| | 52 | 1 | 9 | 1 | 12 | 9 | 4 | 8 | 3 | 12 | B | A |
| | 53 | 1 | 10 | 1 | 12 | 9 | 4 | 8 | 3 | 12 | B | A |
| | 54 | 1 | 11 | 1 | 12 | 9 | 4 | 8 | 3 | 12 | B | A |
| | 55 | 1 | 12 | 1 | 12 | 9 | 4 | 8 | 3 | 12 | B | A |
| | 56 | 1 | 13 | 1 | 1 | 14 | 7 | 11 | 5 | 12 | AA | A |
| | 57 | 1 | 14 | 1 | 1 | 13 | 7 | 10 | 5 | 12 | B | A |
| | 58 | 1 | 1 | 20 | 1 | 16 | 8 | 13 | 7 | 12 | AA | A |
| | 59 | 21 | 1 | 1 | 1 | 16 | 7 | 13 | 5 | 12 | A | B |
| | 60 | 21 | 1 | 21 | 1 | 16 | 7 | 14 | 6 | 12 | A | B |
| | 61 | 22 | 1 | 22 | 1 | 15 | 7 | 11 | 3 | 12 | A | B |
| | 62 | 1 | 1 | 23 | 1 | 16 | 7 | 13 | 5 | 12 | B | A |
| | 63 | 23 | 1 | 24 | 1 | 15 | 7 | 12 | 4 | 12 | B | A |
| | 64 | 1 | 15 | 1 | 13 | 12 | 5 | 12 | 4 | 12 | B | A |
| | 65 | 1 | 4 | 1 | 8 | 14 | 6 | 13 | 5 | 12 | B | A |
| | 66 | 24 | 16 | 25 | 12 | 7.5 | 6 | 6.5 | 4 | 12 | B | B |
| | 67 | 1 | 1 | 1 | 1 | 16 | 7 | 13 | 5 | 12 | AA | A |
| Comparative | 1 | 25 | 1 | 26 | 7 | 7 | 16 | 5 | 13 | 12 | C | A |
| Example | 2 | 25 | 1 | 3 | 1 | 7 | 9 | 5 | 7 | 12 | C | B |
| | 3 | 26 | 1 | 1 | 1 | 7 | 9 | 5 | 7 | 12 | C | B |
| | 4 | 27 | 1 | 17 | 1 | 13 | 5 | 12 | 3 | 12 | C | C |
| | 5 | 1 | 1 | 1 | 1 | 16 | 7 | 13 | 5 | 12 | C | C |
| | 6 | 22 | 1 | 27 | 1 | 15 | 15 | 11 | 11 | 12 | C | C |
| | 7 | 1 | 1 | 1 | 1 | 16 | 7 | 13 | 5 | 12 | A | A |
| | 8 | 25 | 1 | 26 | 7 | 7 | 16 | 5 | 13 | 12 | A | A |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-139412, filed Aug. 30, 2023 and Japanese Patent Application No. 2024-128716, filed Aug. 5, 2024, which are hereby incorporated by reference herein in their entirety.

What is claimed is:

1. An ink jet recording method of ejecting a first ink, a second ink, a first reaction liquid and a second reaction liquid from a recording head to record an image on a recording medium such that the first ink, the second ink, the first reaction liquid and the second reaction liquid overlap each other on at least a part of a region of the recording medium, the method comprising in the following order:
applying the first reaction liquid to the recording medium;
applying the first ink to a region where the first reaction liquid has been applied;
applying step of applying the second reaction liquid to the recording medium; and
applying the second ink to a region where the second reaction liquid has been applied,
wherein the first ink is an aqueous ink comprising a pigment,
wherein the second ink is an aqueous ink comprising at least one particulate substance selected from the group consisting of a pigment and a resin particle,
wherein the first reaction liquid and the second reaction liquid are respectively an aqueous reaction liquid comprising a reactant that reacts with an ink,
wherein the first reaction liquid comprises a water-soluble cationic resin,
wherein a viscosity of a mixed liquid 1-1 obtained by mixing the first reaction liquid and the first ink at a mass ratio of 7:100 is higher than a viscosity of a mixed liquid 2-1 obtained by mixing the second reaction liquid and the first ink at a mass ratio of 7:100,
wherein a viscosity of a mixed liquid 1-2 obtained by mixing the first reaction liquid and the second ink at a mass ratio of 7:100 is higher than a viscosity of a mixed liquid 2-2 obtained by mixing the second reaction liquid and the second ink at a mass ratio of 7:100, and
wherein a water absorption amount of the recording medium from a start of contact to 30 msec^{1/2} in a Bristow method is 10 mL/m² or less.

2. The ink jet recording method according to claim 1,
wherein the cationic resin of the first reaction liquid is a resin having a structure of a quaternary ammonium salt.

3. The ink jet recording method according to claim 1,
wherein the second reaction liquid contains a water-soluble cationic resin.

4. The ink jet recording method according to claim 3,
wherein a content (% by mass) of the cationic resin in the first reaction liquid is more than a content (% by mass) of the cationic resin in the second reaction liquid.

5. The ink jet recording method according to claim 1,
wherein a surface tension of the second reaction liquid is higher than a surface tension of the first reaction liquid.

6. The ink jet recording method according to claim 1,
wherein the pigment of the first ink is titanium oxide.

7. The ink jet recording method according to claim 1,
wherein the viscosity of the mixed liquid 1-1 obtained by mixing the first reaction liquid and the first ink at a mass ratio of 7:100 is twice or more of the viscosity of the mixed liquid 2-1 obtained by mixing the second reaction liquid and the first ink at a mass ratio of 7:100.

8. The ink jet recording method according to claim 1,
wherein the first reaction liquid comprises at least one selected from the group consisting of a polyvalent metal salt and an organic acid.

9. The ink jet recording method according to claim 1,
wherein a content (% by mass) of the reactant in the first reaction liquid is more than a content (% by mass) of the reactant in the second reaction liquid.

10. The ink jet recording method according to claim 1,
wherein the first ink further contains a water-soluble resin.

11. The ink jet recording method according to claim 10,
wherein the second ink further comprises a water-soluble resin, and
wherein an acid value of the water-soluble resin in the first ink is more than an acid value of the water-soluble resin in the second ink.

12. The ink jet recording method according to claim 1,
wherein the first ink is a white ink, and
wherein the second ink is a non-white ink.

13. The ink jet recording method according to claim 1,
wherein the first ink is a white ink, and
wherein the second ink is a clear ink containing no pigment.

14. The ink jet recording method according to claim 1,
wherein the first ink and the second ink, and the first reaction liquid and the second reaction liquid are respectively applied to a unit area of the recording medium by relative scanning of the recording head and the recording medium carried out a plurality of times.

15. The ink jet recording method according to claim 1,
wherein the first ink and the second ink, and the first reaction liquid and the second reaction liquid are respectively applied to a unit area of the recording medium by relative scanning of the recording head and the recording medium carried out once, and
wherein a difference in time between the application of the first ink and the application of the second reaction liquid to a unit area is 5 second or longer.

16. An ink jet recording device used to eject a first ink, a second ink, a first reaction liquid and a second reaction liquid from a recording head to record an image on a recording medium such that the first ink, the second ink, the first reaction liquid and the second reaction liquid overlap each other on at least a part of a region of the recording medium, the device comprising in the following order:
a first reaction liquid applying unit configured to apply the first reaction liquid to the recording medium;
a first ink applying unit configure to apply the first ink to a region where the first reaction liquid has been applied;
a second reaction liquid applying unit configured to apply the second reaction liquid to the recording medium; and
a second ink applying unit configured to apply the second ink to a region where the second reaction liquid has been applied,
wherein the first ink is an aqueous ink comprising a pigment,
wherein the second ink is an aqueous ink comprising at least one particulate substance selected from the group consisting of a pigment and a resin particle,
wherein the first reaction liquid and the second reaction liquid are respectively an aqueous reaction liquid comprising a reactant that reacts with an ink,
wherein the first reaction liquid comprises a water-soluble cationic resin,
wherein a viscosity of a mixed liquid 1-1 obtained by mixing the first reaction liquid and the first ink at a mass ratio of 7:100 is higher than a viscosity of a mixed liquid 2-1 obtained by mixing the second reaction liquid and the first ink at a mass ratio of 7:100,
wherein a viscosity of a mixed liquid 1-2 obtained by mixing the first reaction liquid and the second ink at a mass ratio of 7:100 is higher than a viscosity of a mixed liquid 2-2 obtained by mixing the second reaction liquid and the second ink at a mass ratio of 7:100, and
wherein a water absorption amount of the recording medium from a start of contact to 30 msec^{1/2} in a Bristow method is 10 mL/m² or less.
